(19) United States
(12) Patent Application Publication
(10) Pub. No.: US 2010/0183301 A1
(43) Pub. Date: Jul. 22, 2010

(54) APPARATUS SUITABLE FOR TRANSPORTING CLIENT SIGNALS, AND APPARATUS AND METHOD SUITABLE FOR MAPPING OR DEMAPPING TRIBUTARY SLOTS FOR TRANSPORT OF CLIENT SIGNALS

(76) Inventors: Jong-yoon SHIN, Daejeon-si (KR); Jong-ho KIM, Daejeon-si (KR); Je-soo KO, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/617,529

(22) Filed: Nov. 12, 2009

(30) Foreign Application Priority Data
Nov. 13, 2008 (KR) 10-2008-0112945
Aug. 11, 2009 (KR) 10-2009-0073804

(51) Int. Cl. H04J 14/00

(52) U.S. Cl. 398/45

(57) ABSTRACT

Disclosed area method and apparatus of transporting client signals and a method and apparatus of mapping or demapping tributary slots for transport of client signals. The client signal transporting apparatus defines a bit rate of an optical transport signal, and bit-transparently maps and multiplexes client signals that operate at the defined bit rate. Also, the client signal transporting apparatus adjusts a bandwidth by extending a mapping area to increase a data capacity to be allocated to tributary slots.

### CROSS-REFERENCE TO RELATED APPLICATION

This application claims the benefit under 35 U.S.C. §119(a) of Korean Patent Applications No. 10-2008-112945, filed on Nov. 13, 2008 and No. 10-2009-73804, filed on Aug. 11, 2009, the disclosures of which are incorporated by reference in its entirety for all purposes.

### BACKGROUND

1. Field

The following description relates to an optical transport network (OTN), and more particularly, to a technology suitable for transporting client signals using the Optical Transport Hierarchy (OTH).

2. Description of the Related Art

The ITU-T G.709 standard specifies Optical channel Transport Units (OTUk) and Optical channel Data Units (ODUk) in order to stably transport high-speed optical signals requiring a large bandwidth. According to the ITU-T G 709 standard, OTU1 has a bit rate of about 2.666 Gbit/s, OTU2 has a bit rate of about 10.709 Gbit/s, OTU3 has a bit rate of about 43.018 Gbit/s and OTU4 has a bit rate of about 111.809 Gbit/s. Among Synchronous Digital Hierarchy (SDH) client signals that can be transported over an optical transport network (OTN), STM-256 has the highest bit rate of about 39.81312 Gbit/s and either of OTU3 or ODU3 can accept the bit rate.

Meanwhile, the payload area of an ODUk frame is composed of 3808 byte columns by 4 rows. Since 3808 is divisible by 32, upon dividing ODU3 in units of 32 tributary slots, each tributary slot has a capacity of about 1.254 Gbit/s. Accordingly, ODU3 can contain maximally 32 1 GbE signals by mapping a 1 GbE signal into each tributary slot and multiplexing it.

Also, when ODU4 is divided in units of 80 tributary slots, each tributary slot has a capacity of about 1.3017 Gbit/s and thus multiplexing of ODU3 into ODU4 requires only 32 tributary slots. If a data tributary unit that can be contained in 32 tributary slots is referred to as ODTU4.32, the ODTU4.32 has a capacity of about 41.654 Gbit/s and also ODU3 has a capacity of 40.654 Gbit/s. Accordingly, ODU3 can be mapped into ODTU4.32. The mapped to ODTU4.32 is mapped into ODU4 using 32 of 80 tributary slots.

However, since a payload capacity of OTU2 is about 99.952 Gbit/s and the capacity of 10 GbE is 10.3125 Gbit/s, a 10 GbE signal cannot be bit-transparently mapped into OTU2. Accordingly, in order to bit-transparently map a 10 GbE signal, an ODU2e signal having a capacity of 10.3995 Gbit/s is defined and used.

Furthermore, since the capacity of a 40 GbE signal is 41.25 Gbit/s and the payload capacity of ODU3 is about 40.15 Gbit/s, the 40 GbE signal has a bandwidth larger than ODU3 and accordingly, the 40 GbE signal cannot be bit-transparently mapped into ODU3. In other words, since the conventional optical transport signals are defined based on the SDH, there are limitations in bit-transparently mapping Ethernet signals.

### SUMMARY

The following description relates to a technology capable of adjusting the bandwidths of client signals while bit-transparently receiving and multiplexing the client signals over an optical transport network (OTN).

According to an exemplary aspect, there is provided a client signal transporting apparatus which transports a client signal using the Optical Transport Hierarchy (OTH) over an optical transport network, including: a tributary slot allocation unit to allocate a part of a payload area of an optical transport signal equally in units of a predetermined number of tributary slots and to allocate the remaining part of the payload area in units of a predetermined number of extra tributary slots or a predetermined number of fixed stuff bytes; and an optical multiplexing unit to map a client signal into the payload area using the allocated tributary slots and the allocated extra tributary slots and multiplex the mapped client signal into a higher layer optical transport signal.

According to another exemplary aspect, there is provided a tributary slot mapping apparatus which transports a client signal using the optical transport hierarchy (OTH) over an optical transport network, including: a data mapper to map data into tributary slots; a multiplex structure identifier generator to generate tributary port information for the tributary slots; an extended multiplex structure identifier generator to generate extra tributary port information for extra tributary slots; and an overhead and data selecting unit to set an overhead to transfer a payload structure identifier including the multiplex structure identifier and the extended multiplex structure identifier to an overhead area of the payload structure identifier, and to transfer the data mapped to the tributary slots to a data area.

According to another exemplary aspect, there is provided a tributary slot demapping apparatus which transports a client signal using the optical transport hierarchy (OTH) over an optical transport network, including: a frame extracting unit to receive a mapped frame and extract payload structure identifier information from the mapped frame; a payload structure identifier checker to verify whether the most significant bits of extended multiplex structure identifier information are all zero in the payload structure identifier information; and a data demapper to decode, if the most significant bits of the extended multiplex structure identifier information are all zero, multiplex structure information using tributary port information of the payload structure identifier and demap a data signal from a tributary slot area according to the decided multiplex structure information, and to decode, if all of the most significant bits of the extended multiplex structure identifier information are not zero, extended multiplex structure information using tributary port information of the multiplex structure identifier and the extended multiplex structure identifier and demap a data signal from a tributary slot area including an extra tributary slot area according to the decided, extended multiplex structure information.

According to another exemplary aspect, there is provided a client signal transporting method which transports a client signal using the optical transport hierarchy (OTH) over an optical transport network, including: allocating a part of a payload area of an optical transport signal equally in units of a predetermined number of tributary slots, and allocating the remaining part of the payload area in units of a predetermined tributary slots or in units of a predetermined number of fixed stuff bytes; and mapping a client signal into the payload area using the allocated tributary slots and the allocated extra tributary slots, and multiplexing the mapped client signal into a higher layer optical transport signal.

Therefore, the client signal transporting apparatus defines a bit rate of the optical transport hierarchy, and bit-transparently maps and multiplexes a client signal which can be received at the defined bit rate. The client signal transporting apparatus may define a range of a bit rate of an optical channel data unit 4e (ODU4e) and a bit rate which ODU3+ can have, and receive and multiplex 10 GbE, 40 GbE and 100 GbE signals within the defined bit rate range. Moreover, the client signal transporting apparatus may extend a mapping region to increase a data capacity in which tributary slots can be allocated, thereby adjusting a bandwidth.

Other objects, features and advantages will be apparent from the following description, the drawings, and the claims.

### BRIEF DESCRIPTION OF THE DRAWINGS

FIG. 1 illustrates a configuration of a client signal transporting apparatus according to an exemplary embodiment.

FIGS. 2A and 2B illustrate a tributary slot allocated structure of OPU4e according to an exemplary embodiment.

FIG. 3 and FIG. 4 illustrate ODTU3y4e frame structures that are mapped into tributary slots of ODU4e, according to various exemplary embodiments.

FIGS. 5A and 5B illustrate a tributary slot allocated structure of OPU4e in which fixed stuff bytes are allocated, according to an exemplary embodiment.

FIGS. 6A and 6B illustrate a tributary slot allocated structure of OPU4e in which extra to tributary slots are allocated, according to an exemplary embodiment.

FIGS. 7A and 7B illustrate a tributary slot allocated structure of OPU4e in which extra tributary slots and fixed stuff bytes are allocated, according to an exemplary embodiment.

FIGS. 8A through 8E illustrate a general ODTU3y4e frame structure.

FIGS. 9A through 9E illustrate an ODTU3y4e.3 frame structure according to an exemplary embodiment.

FIG. 10 illustrates an overhead structure of OPU3e according to an exemplary embodiment.

FIGS. 11, 12 and 13 respectively illustrate multiframe structures showing corrected PSI bytes, corrected MSI bytes and corrected EMSI bytes of an OPU4e overhead, to map ODU3+ into ODU4e, according to an exemplary embodiment.

FIG. 14 shows an example of the MSI and EMSI bytes illustrated in FIGS. 12 and 13.

FIGS. 15A, 15B, 16A and 16B illustrate tributary slot allocated structures of OPU4e in which extra tributary slots are used, according to other exemplary embodiments.

FIG. 17 illustrates an ODTU4e.32 frame structure that is used to multiplex 32 tributary slots of OTU4e, according to an exemplary embodiment.

FIG. 18 illustrates an ODTU4e.32y frame structure to which 3 byte rows are added, according to an exemplary embodiment.

FIG. 19 illustrates a PSI structure of ODTU4e.32y3 used when an ODTU4e.32y3 signal is multiplexed to an ODU4e signal, according to an exemplary embodiment.

FIGS. 20A, 20B and 20C show an example of MFI and EMFI bytes illustrated in FIG. 19.

FIG. 21 illustrates a configuration of a tributary slot mapping apparatus according to an exemplary embodiment.

FIG. 22 illustrates a configuration of a tributary slot demapping apparatus according to an exemplary embodiment.

FIGS. 23A and 23B show timing diagrams regarding tributary slots and extra tributary slots areas that are demapped by the tributary slot demapping apparatus, according to an exemplary embodiment.

FIG. 24 is a flowchart illustrating a tributary slot demapping method according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

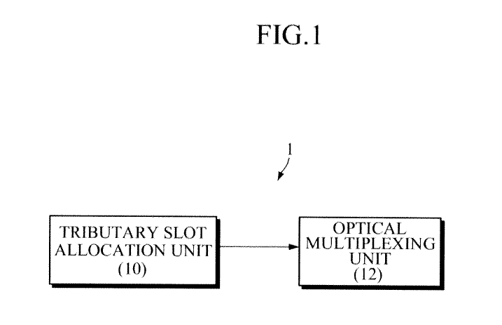

FIG. 1 illustrates a configuration of a client signal transporting apparatus 1 according to an exemplary embodiment.

Referring to FIG. 1, the client signal transporting apparatus 1 includes a tributary slot allocation unit 10 and an optical multiplexing unit 12. The client signal transporting apparatus 1 transports client signals using the Optical Transport Hierarchy (OTH) over an Optical Transport Network (OTN). The client signals include packet signals such as Ethernet hierarchy signals, Synchronous Digital Hierarchy (SDH) signals, and successive signals such as video signals.

According to an exemplary embodiment, a signal having a bit rate which is higher than an optical channel data unit 3 (ODU3) is defined to bit-transparently and efficiently receive 4 10 GbE signals or a 40 GbE signal, which are client signals. The newly defined signal will be hereinafter referred to as ODU3+. In consideration of multiplexing 4 bit-transparently received ODU2e signals corresponding to 4 10 GbE signals to ODU3+, the bit rate of ODU3+ has to be at least 41.774 Gbit/s (239/236×4×10.3125 Gbit/s).

However, since increasing a bit rate of ODU3+ up to a bit rate of ODU4 without limitation is inefficient, the bit rate of ODU3+ may be fitted to be less than 41.654 Gbit/s which is the bit rate of ODTU4.32. This is because if the bit rate of ODU3+ exceeds the data capacity of ODTU4.32, the ODU3+ has to be mapped into ODTU4.33 using 33 tributary slots, instead of being mapped into ODTU4.32 using 32 tributary slots.

However, as described above, since ODU3+ has to have a bit rate of at least 41.774 Gbit/s in order to bit-transparently receive and map 4 10 GbE signals or a 40 GbE signal, in this case, an ODU3+ signal cannot be mapped into ODTU4.32 having a data capacity of 41.654 Gbit/s. That is, increasing the bit rate of ODU3+ to be a little higher than that of ODU3 simply maps the ODU3+ into ODTU4.33 further using a tributary slot of a 1.3017 Gbit/s level of OTU4.

In the case of multiplexing two ODU3 signals to OTU4, 64 tributary slots among 80 tributary slots of a 1.3017 Gbit/s level are used, and the remaining 16 tributary slots can be used to map 2 ODU2 or ODU2e signals or to map 8 ODU1 signals or 16 ODU0 signals. However, in the case of multiplexing 2 ODU3+ signals to OTU4, 66 tributary slots among 80 tributary slots of a 1.3017 Gbit/s level are used, and the remaining 14 tributary slots can map only a ODU2 or ODU2e signal or map 7 ODU1 signals or 14 ODU0 signals. That is, the multiplexing of ODU3+ to OTU4 is accompanied by inefficient mapping.

As understood from the above description, since existing optical transport network (OTN) signals are not suitable to bit-transparently map 10 GbE and 40 GbE signals which are received as to client signals, it is inevitable that a new OTU4e signal having a bit rate which is a little higher than that of an OTU4 signal needs to be defined.

According to an exemplary embodiment, a lowest bit rate of OTU4e which can be acquired through the existing inefficient mapping is defined as 112.3047 Gbit/s (255/226×40×2.48832 Gbit/s). In this case, a bit rate of ODU4e is 239/255×(a bit rate of OTU4). Also, when ODU4e is divisible in units of 80 tributary slots, each tributary slot has a capacity of about 1.307469 Gbit/s. If a data tributary unit which corresponds to 32 tributary slots of ODU4e is referred to as ODTU4e.32, ODTU4e.32 has a capacity of about 41.84 Gbit/s. Accordingly, if ODU3+ has a capacity which is greater than 41.774 Gbit/s (239/236×4×10.3125 Gbit/s) and less than 41.84 Gbit/s (3800/3808×32/80×238/226×40×2.48832 Gbit/s), then ODU3+ can be mapped into ODTU4e.32. The mapped ODTU4e.32 is multiplexed to 32 tributary slots among 80 tributary slots of ODU4e. That is, multiplexing of ODU3+ into ODU4e is performed using only 32 tributary slots.

According to another exemplary embodiment, a bit rate of OTU4e may be defined to be greater than 111.83688 Gbit/s (102/95×80/32×239/255×243/217×16×2.48832 Gbit/s) and less than 112.16234 Gbit/s (4080/1524×239/236×4×10.3125 Gbit/s). For example, a bit rate of OTU4e is defined as 111.9744 (9/8×40×2.48832) Gbit/s. Since a bit ate of 28 Gbit/s is generally considered to allow signal transport on a PCB not through a cable, a bit rate of OTU4e may be set to be within 112 (4×28) Gbit/s in consideration of 28 Gbit/s optical transport for 4 channels.

As such, a bit rate of OTU4e is defined within an allowable range of bit rates for OTU4e, then an ODU3+ signal which can be received within the bit rate range is defined, and thereafter the ODU3+ signal is multiplexed to ODU4e. For example, it is possible to bit-transparently receive and map two 40 GbE signals and two 10 GbE signals, to multiplex the signals to OTU4e/ODU4e and then to transport the multiplexed signal. Alternatively, it is possible to bit-transparently map and multiplex a 40 GbE signal and 6 10 GbE signals and transport the result as an OTU4e/ODU4e frame. Moreover, even in multiplexing arbitrary ONU signals having flexibility, as well as 40 GbE and 10 GbE signals, to ODU4, it is possible to increase a capability of receiving and mapping the ODU signals having flexibility by extending a mapping area.

For the multiplexing, the tributary slot allocation unit 10 allocates a predetermined number of tributary slots equally to a part of a payload area of an optical transport signal, and allocates extra tributary slots or fixed stuff bytes to the remaining part of the payload area.

Meanwhile, the optical transport signal may be ODUk (k=1, 2, 2e, 3, 3+, 4, 4e, flex). For example, an optical transport signal ODU3+ divides its payload area equally to 32 tributary slots, and 8 tributary slots thereof are used to bit-transparently receive, map and multiplex a 10 GbE signal. That is, through a single ODU3+ signal, 4 10 GbE signals can be bit-transparently received and mapped. In the following description, ODU4e which is an optical transport signal will be given as an example. In this case, the optical multiplexing unit 12 can map ODU3+ into OTU4e, but also can extend an arbitrary ODUk (k=1, 2, 2e, 3 flex) to ODUk+ and then map the ODUk+ into OTU4e, so as to extend a mapping area.

In order to efficiently transport client signals, a payload area of an OPH signal may be allocated tributary slots in various manners. The number of tributary slots that are allocated to a part of a payload area of an optical transport signal ODU4e by the tributary slot allocation unit 10 may be 40 or 80. However, payload bytes of an ODUk frame consist of 4 rows each having 3808 bytes and thus are not divisible by 40 or 80. In this case, allocation of tributary slots as follows can be considered.

According to an exemplary embodiment, the tributary slot allocation unit 10 may allocate a predetermined number of tributary slots to a part of a payload area of an optical transport signal, and then, allocate tributary slots, tributary slots+extra tributary slots, or tributary slots+extra tributary slots+fixed stuff bytes to the remaining part of the payload area, in a unit of a predetermined number of multiframes.

According to another exemplary embodiment, the tributary slot allocation unit 10 may allocate tributary slots to a part of a payload area of an optical transport signal, and then, allocate extra tributary slots or extra tributary slots+fixed stuff bytes to the remaining part of the payload area, in a unit of a predetermined number of rows.

Meanwhile, the optical multiplexing unit 12 receives and maps client signals using the tributary slots allocated by the tributary slot allocation unit 10 and multiplexes the client signals to the next higher layer optical transport signals. Here, the client signals may be any ones of packet signals such as Ethernet hierarchy signals, synchronous digital hierarchy signals and successive signals such as video signals.

According to an exemplary embodiment, the optical multiplexing unit 12 may set, when receiving and mapping a client signal and multiplexing it into the next higher layer optical transport signal, a bit rate of OTU4e to 111.9744 (9/8×40×2.48832) Gbit/s.

In this case, in order to multiplex ODU3+ to ODU4e at the set bit rate, the optical multiplexing unit 12 may use, when 80 tributary slots are allocated to ODU4e, 32 1.25 G tributary slots each having a capacity of about 1.307469 Gbit/s, and may use, when 40 tributary slots are allocated to ODU4e, 16 2.5 G tributary slots each having a capacity of about 2.60724 Gbit/s.

Hereinafter, a tributary slot allocation method of the tributary slot allocation unit 10 and a multiplexing method of the optical multiplexing unit 12 will be described in detail with reference to the related drawings.

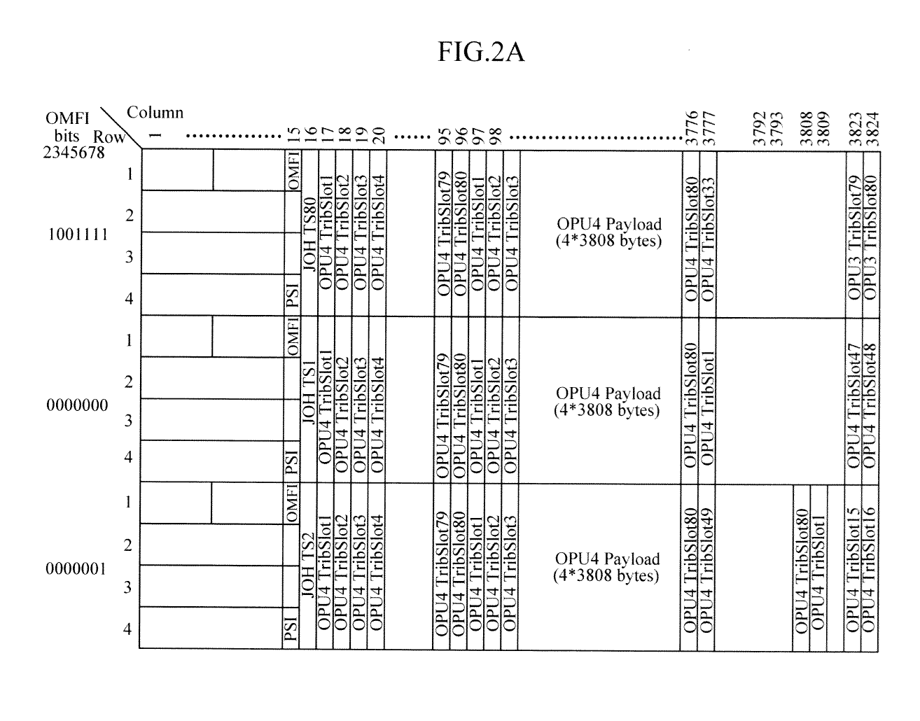

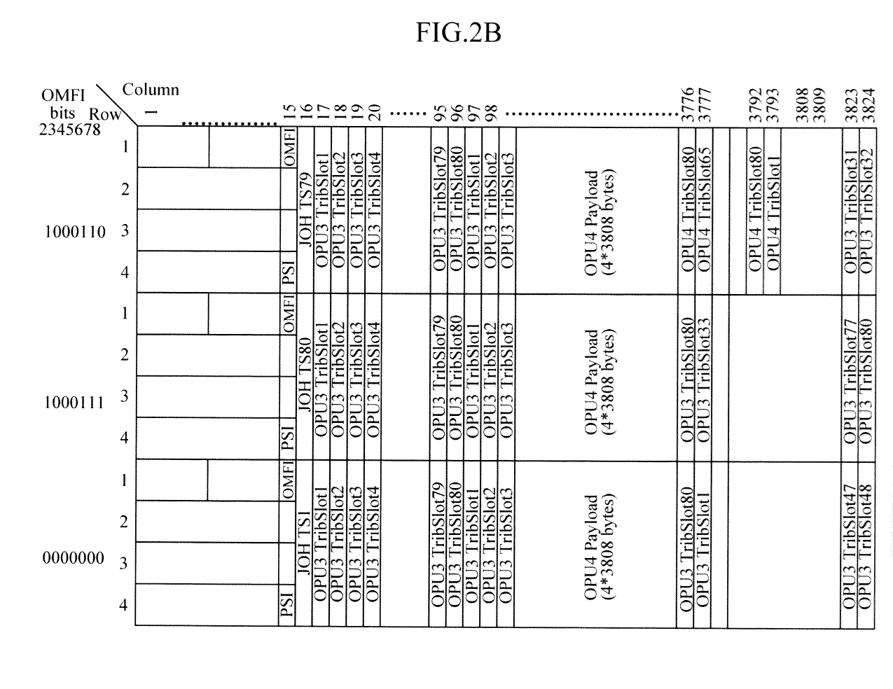

FIGS. 2A and 2B illustrate a tributary slot allocated structure of OPU4e according to an exemplary embodiment.

OPU4e corresponds to a payload area of OTU4e/ODU4e. The payload area is to composed of 3808 byte columns by 4 rows. The 3808 byte columns are not divisible by 80. Accordingly, as illustrated in FIGS. 2A and 2B, the client signal transporting apparatus 1 divides 3760 byte columns equally in units of 80 1.25 G tributary slots. Then, in regard of the remaining 48 byte columns, 240 (48×5) byte columns including 5 multiframes are divided in units of 80 1.25 G tributary slots.

At this time, the client signal transporting apparatus 1 divides the 48 byte columns after the 3776^{th} byte column using 5 multiframes after dividing the 3760 byte columns in units of 80 1.25 G tributary slots. That is, since there are totally 40 (48×5) byte columns, 3 (240/80) byte columns are added for each tributary slot. That is, the structure illustrated in FIGS. 2A and 2B may use different byte columns in 5 multiframes according to used tributary slots. Accordingly, a switch structure needs to be designed which selects none or one of 48 byte columns when allocating a tributary slot. Although tributary slots to be used are designated, the tributary slots are positioned in 3 multiframes of 5 multiframes and the locations of the tributary slots may be different from each other in the 3 multiframes. Accordingly, location information of tributary slots that are positioned in different locations according to multiframes has to be stored in advance or acquired.

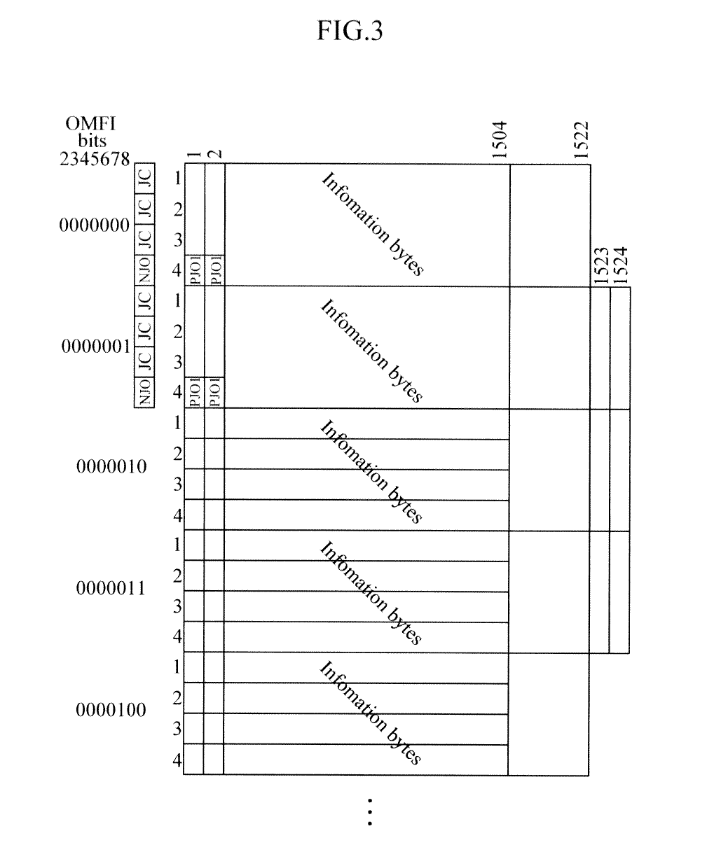

Consequently, the size of an ODTU3y4e frame may depend on which tributary slots are used between the 5 multiframes. ODTU3y4e (Optical Channel Data Tributary Unit-3 into 4) means a data tributary unit which can contain ODU3+ in tributary slots to multiplex the ODU3+ to ODU4e. Also, if there is any byte column after a 1500 byte in an ODTU3y4e frame, the same number of bytes may be mapped into different locations in an ODU4e frame. Accordingly, a complicated hardware structure is needed to be able to arbitrarily allocate byte columns that exist after the 1504^{th} byte of an ODTU3y4e frame to 48 byte columns of the end portion of an OTU4e frame. In the case of mapping ODTU3y4e into ODU4e, since 32 1.25 G tributary slots or 16 2.5 G tributary slots are used, two byte columns exist after the 1504^{th} byte as illustrated in FIG. 3 or no byte column may exist after the 1504^{th} byte.

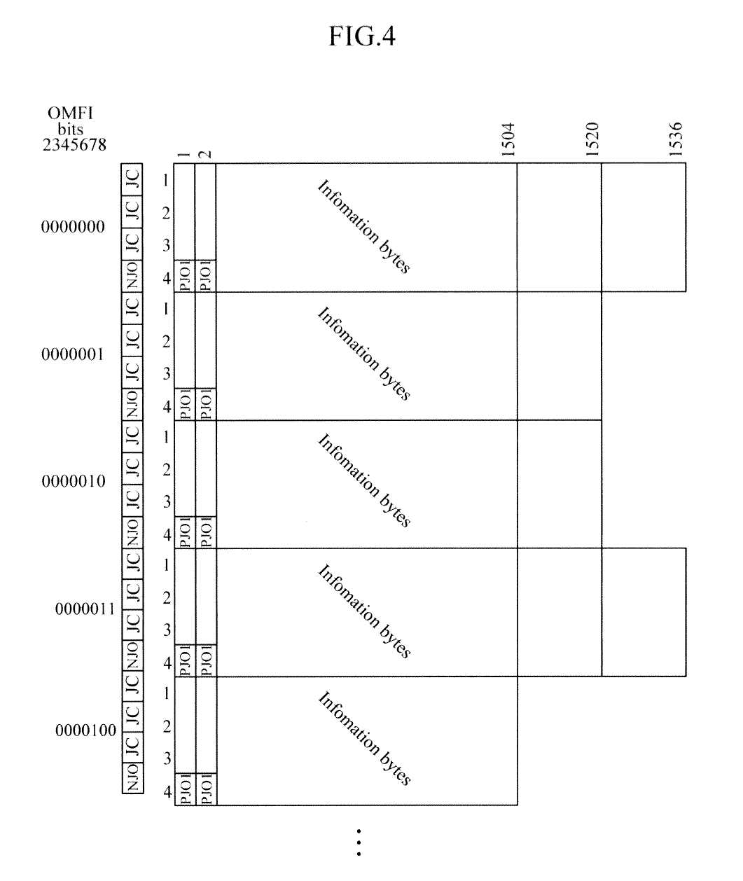

FIGS. 3 and 4 illustrate ODTU3y4e frame structures that upped into tributary slots of ODU4e, according to various exemplary embodiments.

Here, a tributary slot is denoted by TS and FIG. 3 shows a structure of an ODTU3y4e frame that is mapped into TS1, TS2, TS9, TS10, TS11, TS12, TS17, TS18, TS19, TS20, TS25, TS26, TS27, TS28 and TS39 of ODU4e. A client signal transporting apparatus may use an asynchronous mapping procedure (AMP) and a generic mapping procedure (GMP) in order to map ODU3+ into an ODTU3y4e frame structure. The AMP uses Justification Control (JC) bytes specified by the ITU-T G.709 standard to determine whether to use Negative Justification Overhead (NJO) bytes and Positive Justification Overhead (PJO) bytes as data or as fixed stuff bytes, and maps signals according to the results of the determination. The GMP is to decide the locations of stuff bytes in a sigma-delta manner using the number (Cn) of mapped bytes of client information. In order to transfer the Cn value, JC1, JC2, JC3 or more bytes may be used.

Referring to FIG. 3, if it is assumed that the client signal transporting apparatus simply maps ODU3+ into an ODTU3y4E frame structure through the AMP, 80 FS bytes have to be positioned for 40 multiframes of an ODTU3y4e frame. Accordingly, two FS bytes are positioned for each multiframe. Since FS bytes are generally positioned at central locations, the FS bytes may be positioned at 1^{st} and 2^{nd} rows of a 752 (=1504/2)-th column. In the case of using GMP not the AMP, designation on the locations of FS bytes is not needed. In the specification, the locations of FS bytes that are designated depending on various mappings are not described and also not shown in any drawings. Accordingly, the ODTU3y4e frame structure illustrated in FIG. 3 is a generalized structure regardless of the AMP or GMP, and the number and locations of FS bytes may vary depending on which signals of ODU3 signals or ODU3+ signals are mapped.

However, as described above, extra bytes after the 1504^{th} byte column may vary depending on to which tributary slot of ODU4e is mapped OTU3y4e. For example, as illustrated in FIG. 3, 18 bytes columns are added to the first multiframe of ODTU3y4e, and 20 byte columns are added to each of the second, third and fourth multiframes. Finally, 18 byte columns may be added to the fifth multiframe. Here, the ODTU3y4e frame has a structure where five multiframes are repeated periodically.

Unlike the structure, FIG. 4 shows a structure of an ODTU3y4e frame that is mapped into TS1, TS2, TS3, TS4, TS5, TS6, TS7, TS8, TS9, TS10, TS11, TS13, TS14 and TS15 of ODU4.

The ODTU3y4e frame structure illustrated in FIG. 4 is different from the ODTU3y4e frame structure illustrated in FIG. 3 in view of the number of bytes added after a 1504^{th} byte column. That is, as illustrated in FIG. 4, 32 byte columns may be added to the first and fourth multiframes of the ODTU3y4e frame and 16 byte columns may be added to the second and third multiframes. Also, a no byte column is added to the fifth multiframe. Like the structure illustrated in FIG. 3, the ODTU3y4e frame illustrated in FIG. 4 has a structure where five multiframes are repeated periodically.

As illustrated in FIGS. 3 and 4, an ODTU3y4e frame may have different numbers of bytes that are added after a 1504th byte column according to tributary slots. Also, the locations at which the added byte columns are mapped into tributary slots of ODU4e may be arranged differently from those at which the 1-1504 byte columns are mapped, which may increase structural complexity.

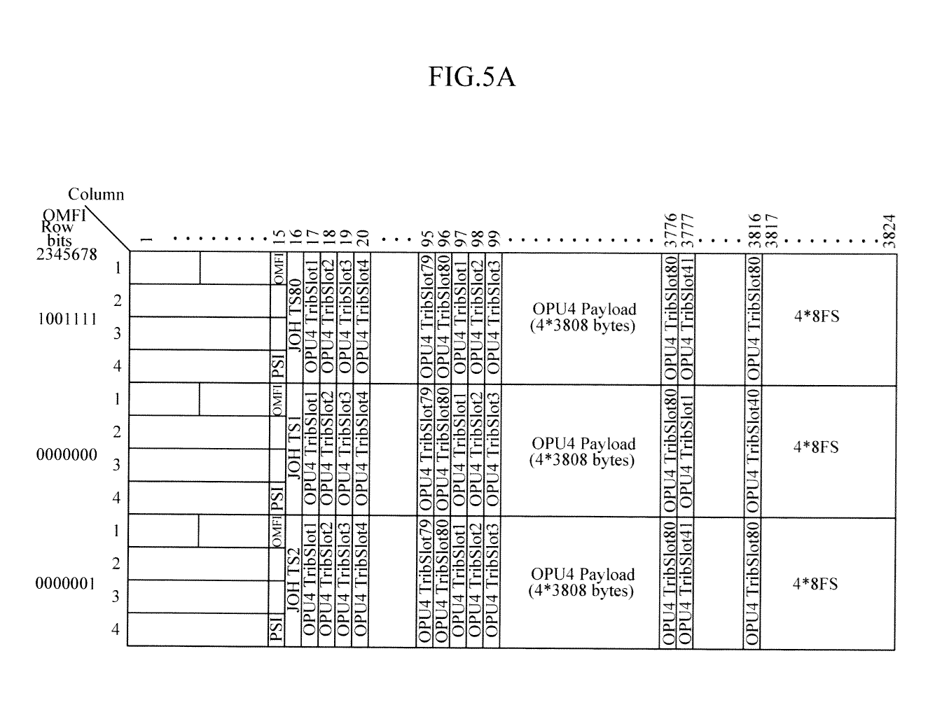

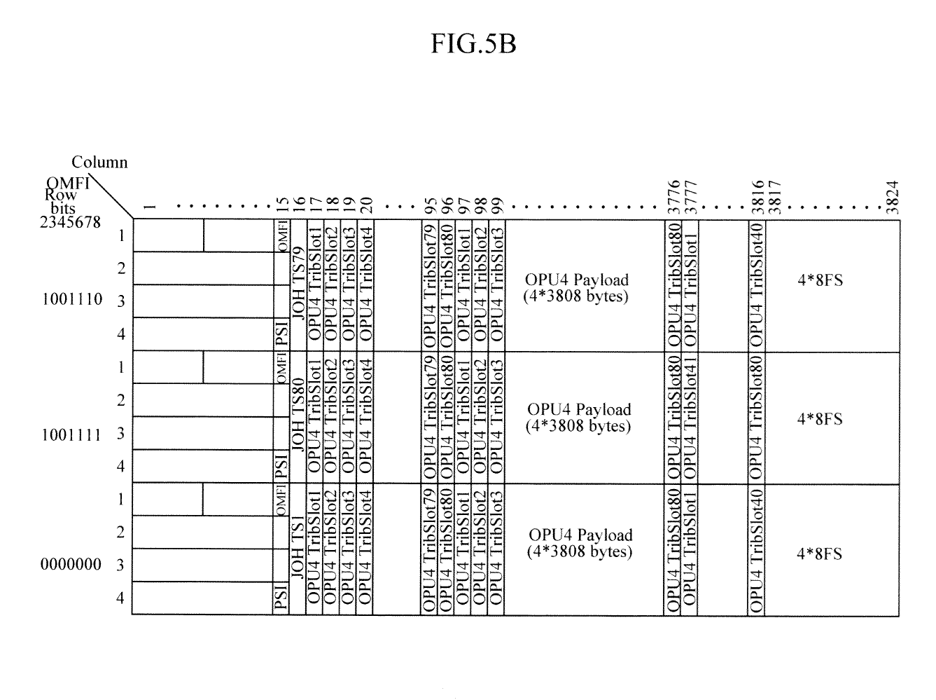

FIGS. 5A and 5B illustrate a tributary slot allocated structure of OPU4e in which fixed stuff bytes are allocated, according to an exemplary embodiment. The OPU4e tributary slot allocated structure illustrated in FIGS. 5A and 5B has been designed to reduce the structural complicity of the structures illustrated in FIGS. 3 and 4.

Referring to FIGS. 5A and 5B, a client signal transporting apparatus divides 3760 byte columns of 3808 byte columns of an OPU4e payload equally in units of 80 1.25 G tributary slots. Then, the client signal transporting apparatus allocates two multiframes each consisting of the remaining 40 byte columns into a unit of 80 1.25 G tributary slots, and allocates the remaining 8 bytes into Fixed Stuff (FS) bytes. In this case, if the allocation is performed in units of 2.5 G tributary slots instead of 1.25 G tributary slots, 3800 byte columns may be divided equally in units of 40 2.5 G tributary slots, without using any of the multiframes shown in FIG. 4. Accordingly, in the case of ODU3+, if mapping into 16 2.5 G tributary slots is possible, a configuration of an ODTU3y4e frame will not be influenced by frame variation due to use of multiframes.

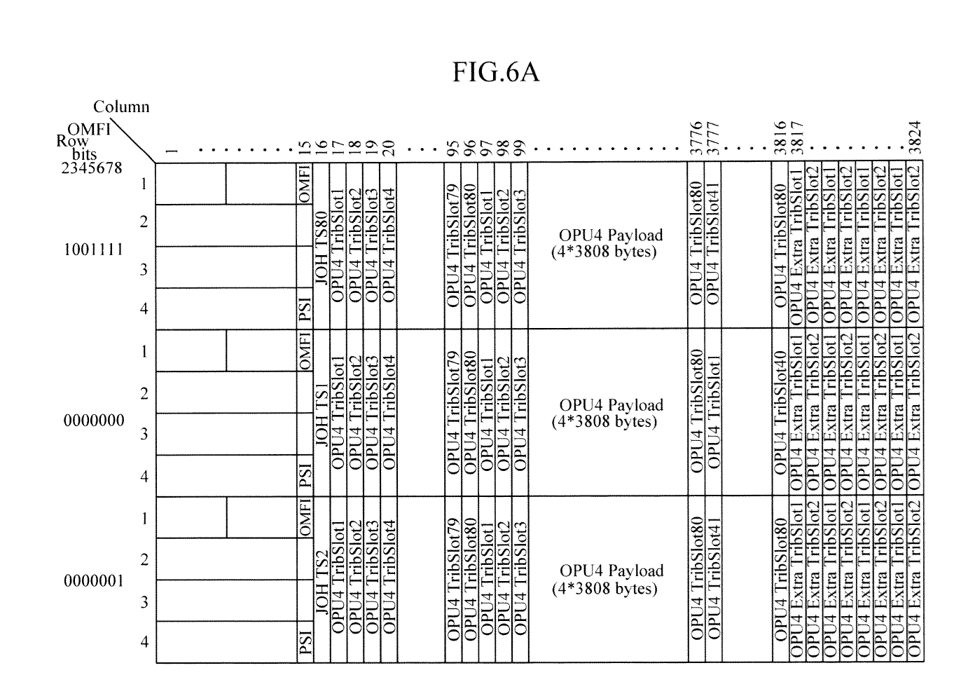

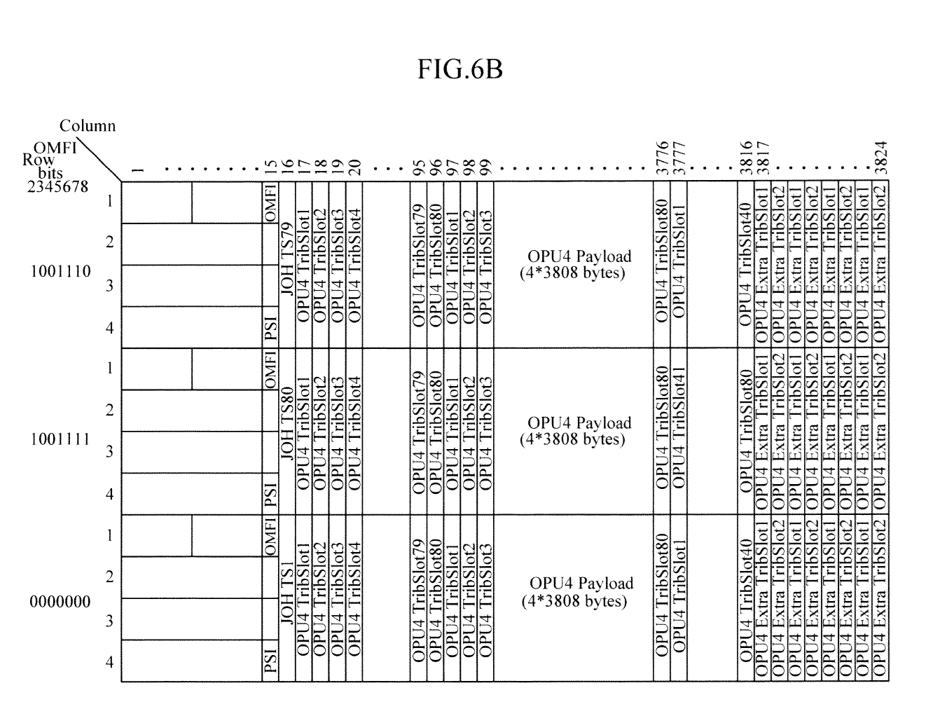

FIGS. 6A and 6B illustrate a tributary slot allocated structure of OPU4e in which extra tributary slots are allocated, according to an exemplary embodiment.

In the tributary slot allocated structure of OPU4e illustrated in FIGS. 5A and 5B, a bit rate of ODTU3y4e is 41.715 952 941 ((OPU4 bit rate)×(3800/3808×32/80)) Gbit/s when ODTU3y4e is configured with 16 2.5 G tributary slots or 32 1.25 G tributary slots in order to map ODU3+. Meanwhile, a bit rate of ODU3+ is 41.785 968 559 (239/255×243/217×16×2.48832) Gbit/s. Accordingly, mapping of ODU3+ into ODTU3y4e may be impossible since there is a lack of about 70 Mbit/s.

However, this mapping impossibility may be resolved by utilizing the tributary slot allocated structure of OPU4e illustrated in FIGS. 6A and 6B.

The client signal transporting apparatus substitutes extra tributary slots shown in FIGS. 6A and 6B for the 3217^{th} to 3824^{th} byte columns (8 byte columns) fixed to FS bytes in the embodiment of FIGS. 5A and 5B. For example, since maximally two ODU3+ can be mapped into ODU4e, the 8 byte columns allocated as FS bytes are allocated to two extra tributary slots. Accordingly, in the case of mapping two ODU3+, 0 to 4 extra tributary slots can be used to be mapped into each ODU3+. When 3 byte columns are used as extra tributary slots to ODTU3y4e, a bit rate is 41.798 287 058 ((OPU4 bit rate)×(3800/3808×32/80+3/3808)) Gbit/1. For convenience of description, a signal in which 3 byte columns are used as extra tributary slots to an ODTU3y4e frame is referred to as ODTU3y4e.3. Accordingly, the ODTU3y4e.3 can map ODU3+ having a bit rate of 41.785 968 559 Gbit/s. For example, a bit rate of ODTU3y4e.4 which uses all of 4 byte columns as extra tributary slots is 41.825 731 764 ((OPU4 bit rate)×(3800/3808×32/80+4/3808)) Gbit/s, and it is sufficient to map ODU3+ whose bit rate is 41.785 968 559 Gbit/s. A capacity to be able to be mapped when 4 byte columns are used as extra tributary slots is greater than a capacity which can be provided by the structure described above in FIGS. 2A and 2B. Also, a bit rate of ODTU3y4e.8 which uses 8 byte columns as extra tributary slots reaches 41. 9355 ((OPU4 bit rate)×(3800/3808×32/80+8/3808)) Gbit/s. Accordingly, the case of using all of extra tributary slots has an increase in capacity of maximally 220 Mbit/s compared to when no extra tributary slot is used. That is, by extending a mapping area using extra tributary slots to increase a data capacity to be able to be allocated to tributary slots, a bandwidth can be adjusted in unit of about 27.444 Mbit/s.

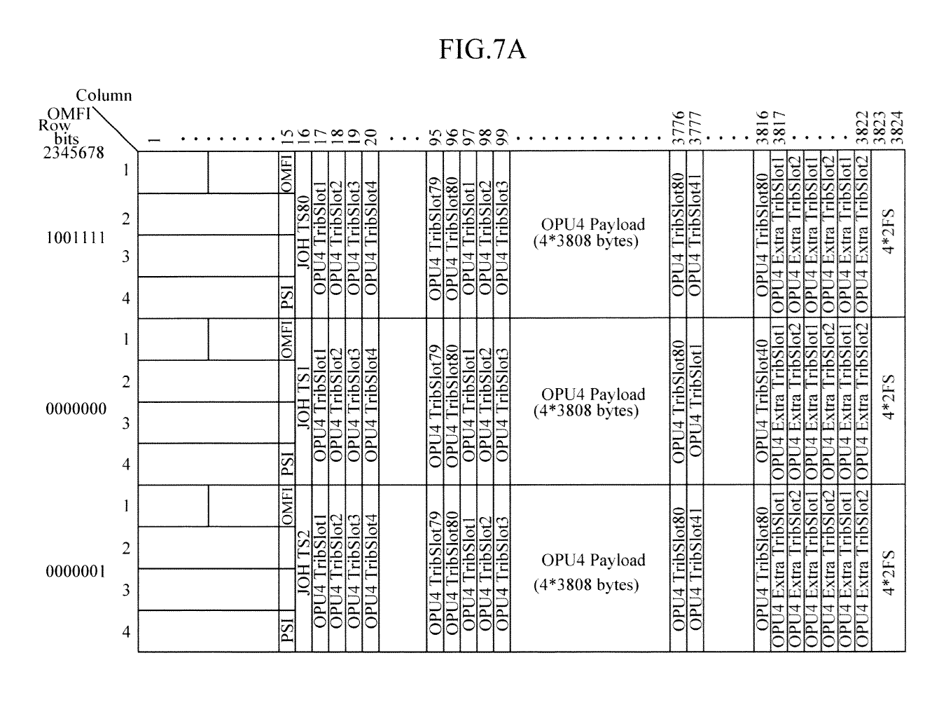

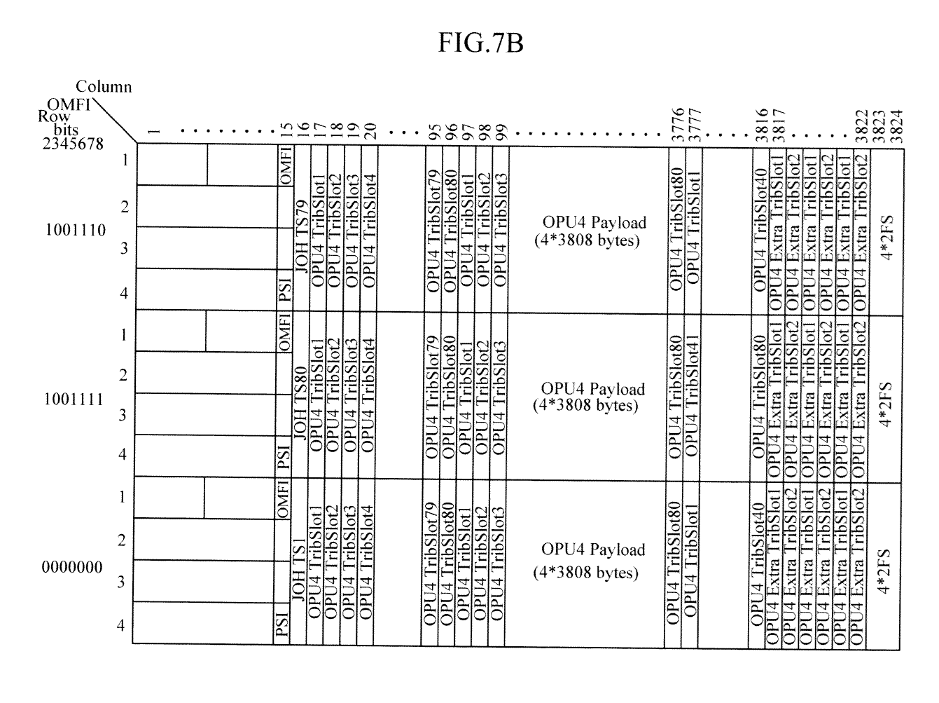

FIGS. 7A and 7B illustrate a tributary slot allocated structure of OPU4e in which extra tributary slots and fixed stuff bytes are allocated, according to an exemplary embodiment. Referring to FIGS. 7A and 7B, the client signal transporting apparatus uses, instead of using all of 4 byte columns as extra tributary slots as illustrated in FIGS. 6A and 6B, only 3 byte columns are used as extra tributary slots and the remaining 2 byte columns are used as FS bytes. This is aimed at supporting further extensibility upon mapping two ODU3+ signals. Here, a frame which has the tributary slot allocated structure of ODU4e illustrated in FIGS. 7A and 7B and can efficiently map ODU3+ into ODU4e using 3 byte columns as extra tributary slots is referred to as ODTU3y4e.3.

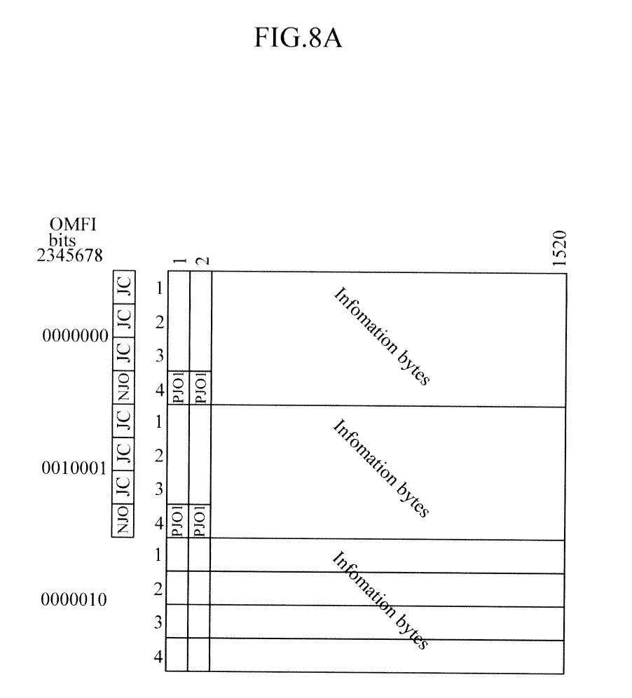

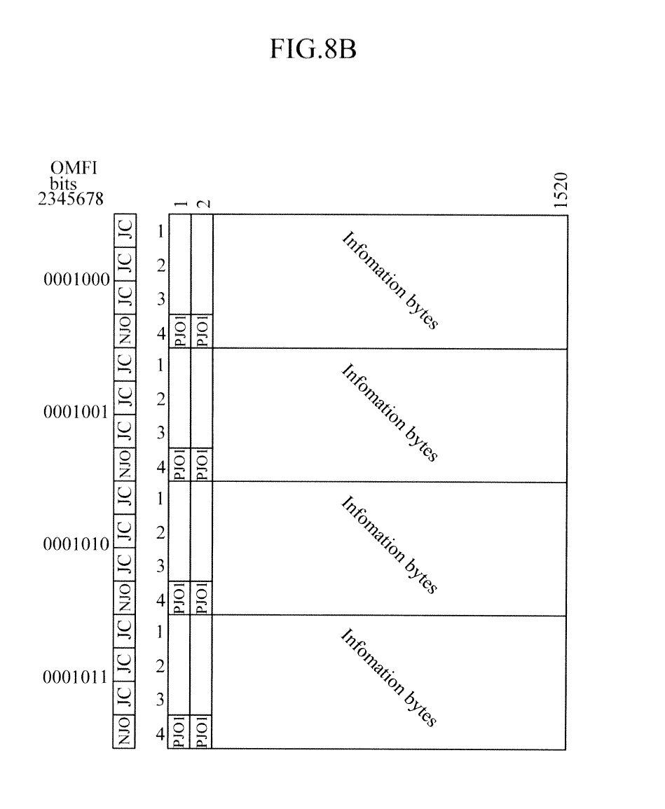

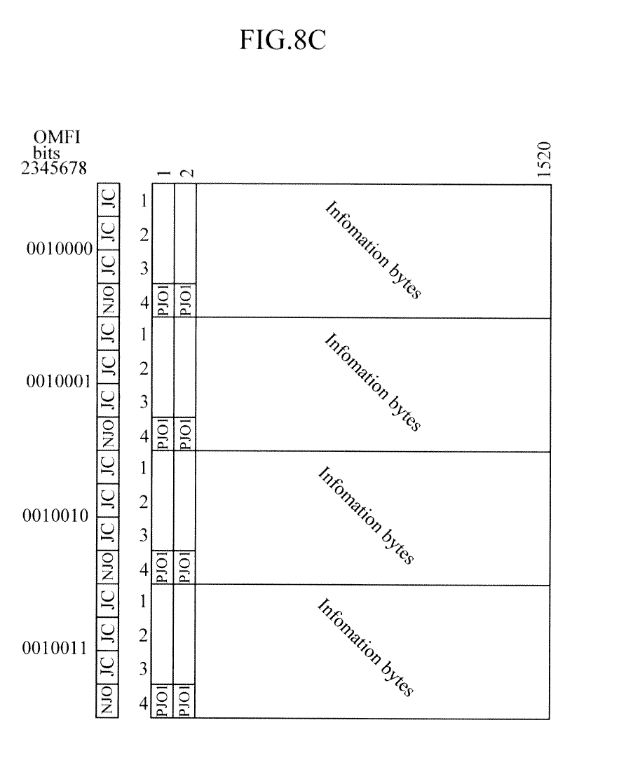

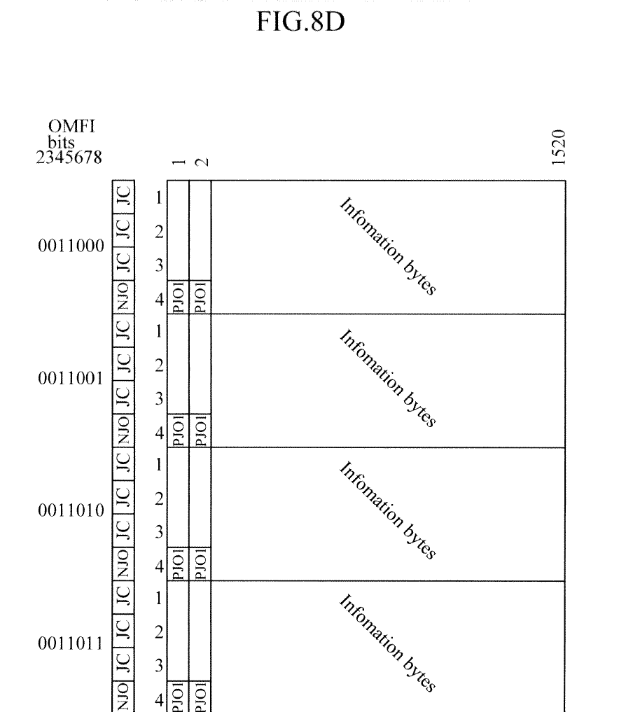

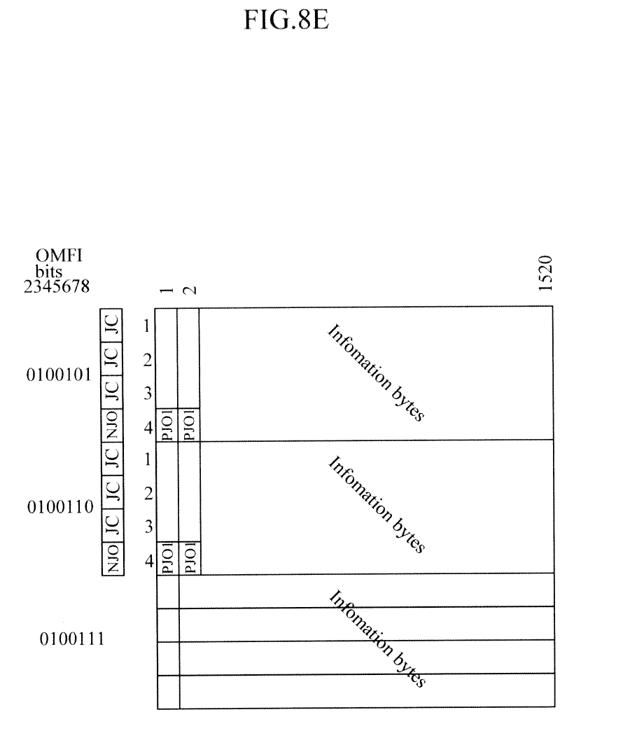

FIGS. 8A through 8E illustrate a general ODTU3y4e frame structure which is mapped into TS1, TS2, TS9, TS10, TS11, TS12, TS17, TS18, TS19, TS20, TS25, TS26, TS27, TS28 and TS39.

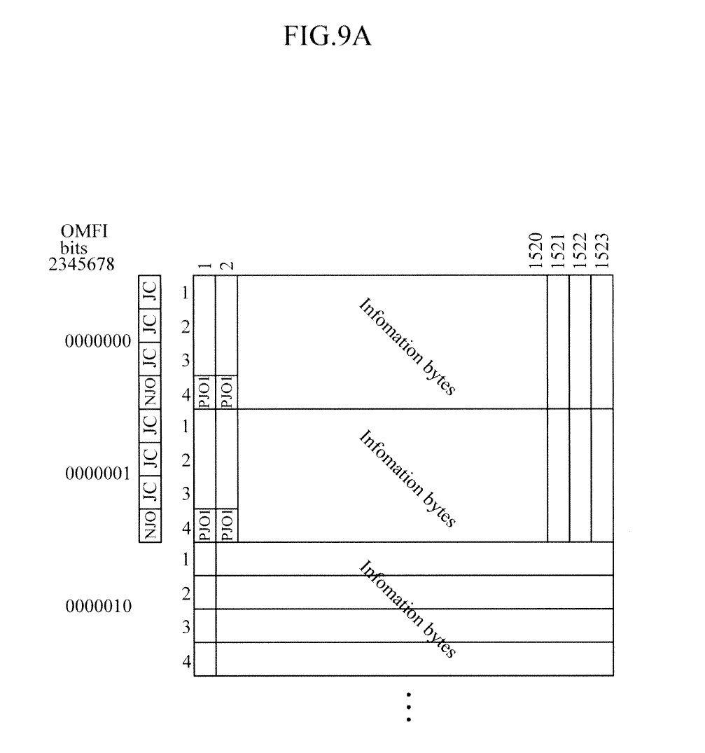

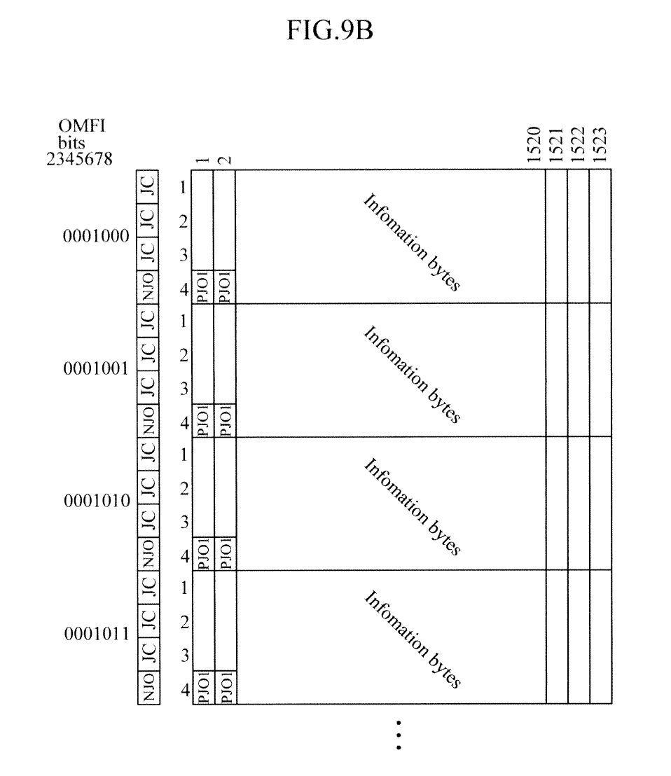

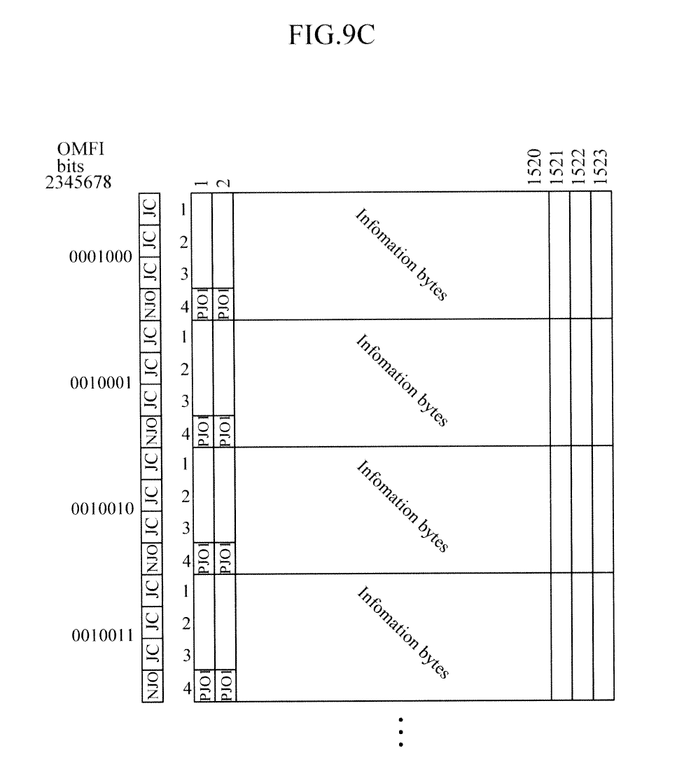

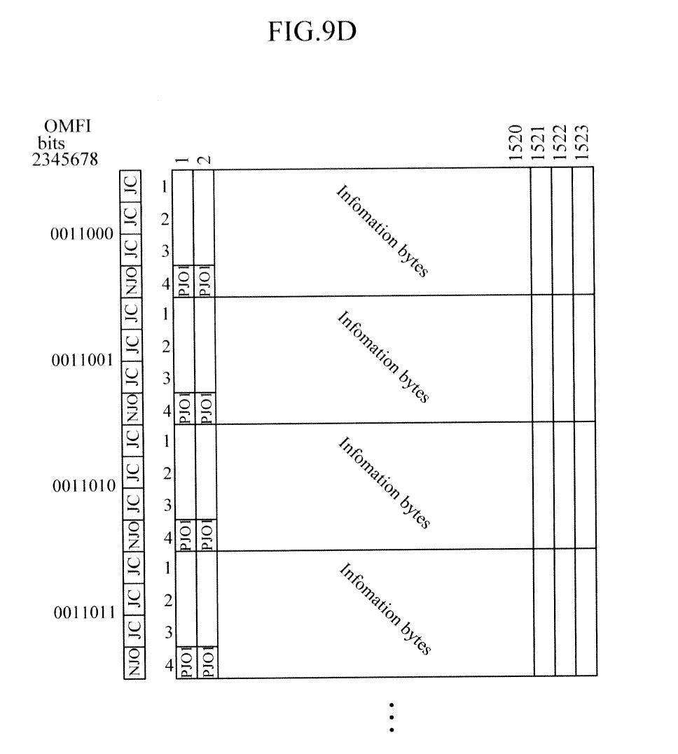

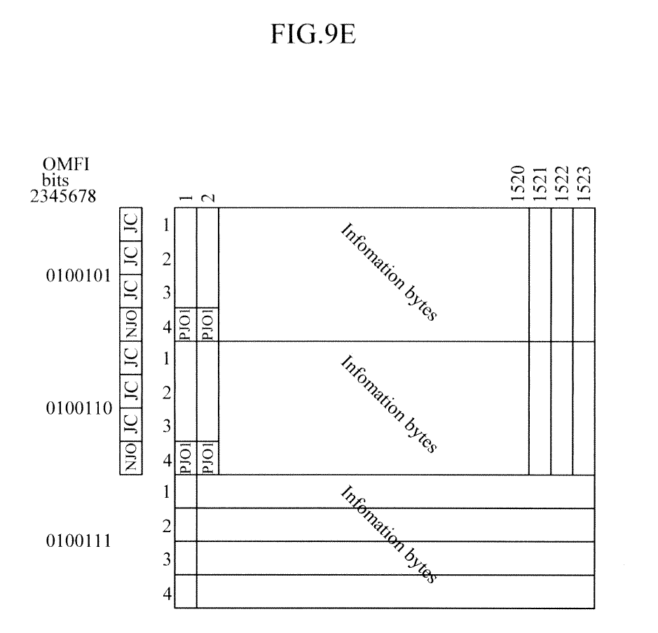

FIGS. 9A through 9E illustrate an ODTU3y4e.3 frame structure according to an exemplary embodiment, which is mapped into TS1, TS2, TS9, TS10, TS11, TS12, TS17, TS18, TS19, TS20, TS25, TS26, TS27, TS28 and TS39.

Referring to FIGS. 9A through 9E, since 3 byte columns have to be used as extra tributary slots upon mapping ODU3+ into ODU4, 3 byte columns are added to the general is ODTU3y4e frame structure described above in FIGS. 9A through 9E. In the ODTU3y4e.3 frame structure, 3 byte columns are added equally to all multiframes each having 1520 byte columns. Accordingly, the ODTU3y4e.3 frame structure illustrated FIGS. 9A through 9E is much simpler than the mapping structure described above with reference to FIG. 4. The client signal transporting apparatus can map an ODU3+ signal into an ODTU3y4e.3 signal and an ODTU3y4e.3 signal to an ODU4 signal.

The client signal transporting apparatus may use multiplex structure identifiers (MSIs) for use of 16 tributary slots when multiplexing an ODTU3y4e signal to an ODU4 signal. Here, since two extra tributary slots have to be distinguished from other tributary slots, the client signal transporting apparatus can correct MSI bytes. In existing MSI bytes, since only 6 bits are allocated to distinguish OPUk tributary slots, the MSI bytes could support 80 tributary slots. Accordingly, the MSI bytes according to the current embodiment may he corrected to support extensibility.

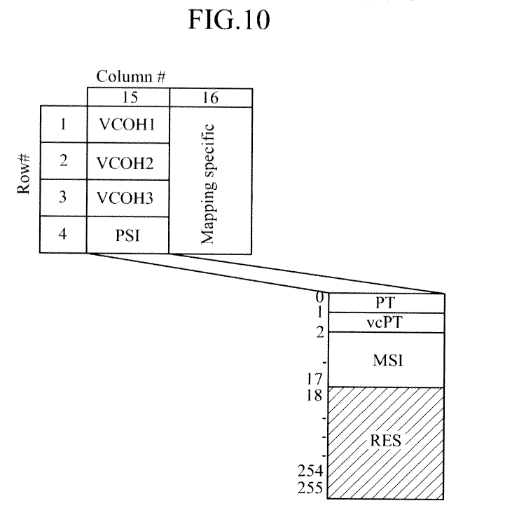

FIG. 10 illustrates an overhead structure of OPU3e according to an exemplary embodiment. Referring to FIG. 10, Payload Structure Identifier (PSI) bytes in the OPU3e overhead are composed of 256 bytes of multiframes. The 2^{nd} to 17^{th} bytes of the 256 bytes are used as MSI bytes. Since the PSI bytes of OPU3e are a total of 256 bytes, simply increasing the area of the MSI bytes cannot ensure mapping into OPU5 or OPU6. Hence, according to an exemplary embodiment, an OPUk overhead is corrected at the lowest degree to support mapping of ODU3+ into ODU4e.

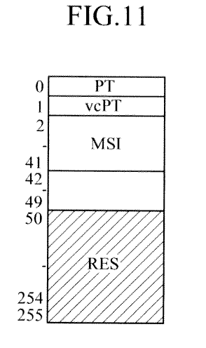

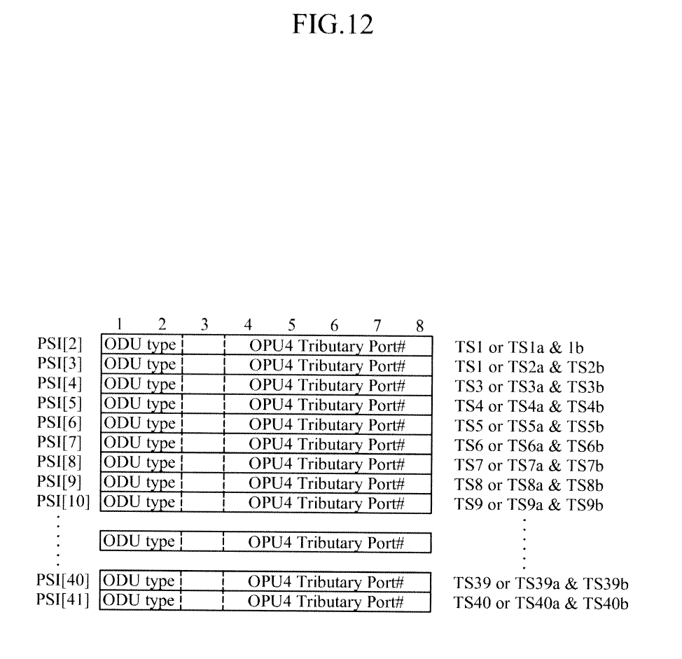

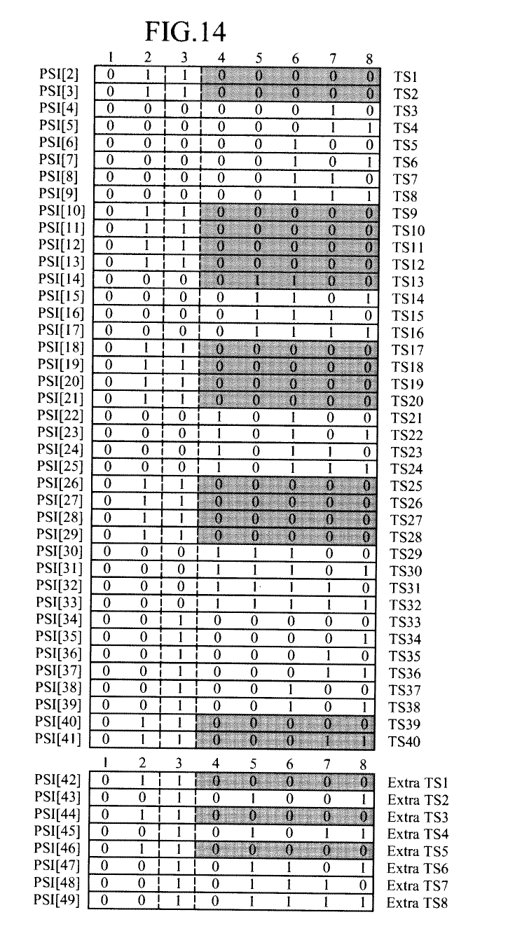

FIG. 11 shows the PSI bytes of an OPU4e overhead corrected for mapping of ODU3+ into ODU4e, according to an exemplary embodiment, FIG. 12 shows a multiframe structure of corrected MSI bytes, and FIG. 14 shows a multiframe structure of corrected Extended Multiplex Structure Identifier (EMSI) bytes.

Referring to FIGS. 11, 12 and 13, when ODU1 and ODU0 are multiplexed to ODU4e, is maximally 40 tributary slots can be used respectively and independently. Accordingly, as illustrated in FIG. 12, the tributary ports of MSI have to support 6 bits such that maximally 40 tributary slots can be used. If the type of ODU is 00x(ODU1) or 11x(ODU0), the 6 bits may be reserved as an area for tributary port information.

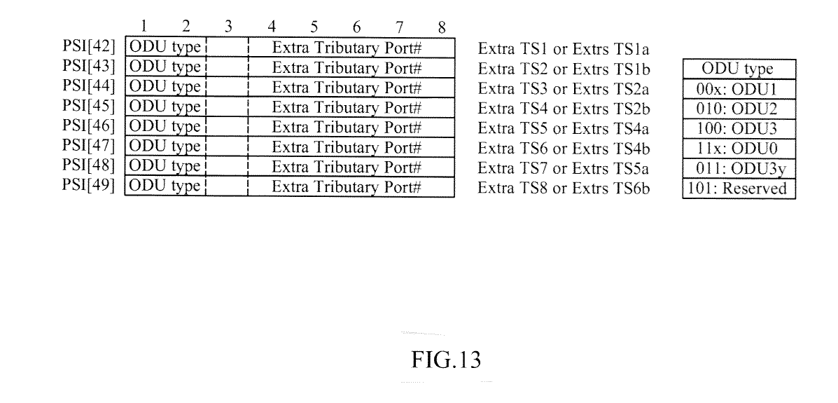

Meanwhile, since ODU2. ODU3 and ODU3+ use 10 or less tributary slots, as illustrated in FIG. 12, only 5 bits are reserved for tributary port information for multiplexing into ODU4e. That is, the third bit is allocated for tributary port information in the case of ODU1 and ODU0 types, but in other types, the third bit may be used to indicate the type of ODU. For example, upon mapping ODU3+ into ODU4e, as illustrated in FIG. 13, by separately setting the type of ODU to “011”, it is easily distinguished that extra tributary slots have been used.

Meanwhile, in the cases of other ODU types except for ODU3+, only MSI bytes can be used. Also, in the case where extra tributary slots have to be used in any other signal types including ODU3+, the EMSI bytes illustrated in FIG. 13 may be used. In this case, in order to provide information on whether to use an extra tributary slot for each of 8 extra byte columns described above with reference to FIGS. 6A and 6B, as illustrated in FIG. 11, the 42^{nd} to 49^{th} bytes of the PSI bytes can be allocated to EMSI bytes and the related tributary slot port information can be provided.

FIG. 14 shows an example of the MSI and EMSI bytes illustrated in FIGS. 12 and 13. Referring to FIG. 14, when TS1, TS2, TS9, TS10, TS11, TS12, TS17, TS18, TS19, TS20, TS25, TS26, TS27, TS28 and TS39 are used as tributary slots for ODTU3y4e.3 and Extra TS1, Extra TS3 and Extra TS5 are used as extra tributary slots, MSI bytes and EMSI bytes can be represented as in FIG. 14.

Referring to FIG. 14, when ODU3+ is mapped to ODU4e, the type of ODU is designated as “011” in PSI bytes that correspond to tributary slots to be mapped, among the MSI bytes, and a tributary port value is “0 0000” or “0 0001”. Here, since 3 extra tributary slots of 8 extra tributary slots have to be used, 3 extra tributary slots to be used among the EMSI bytes are selected, then the type of ODU is designated as “011” which is the same value and an extra tributary port value is set to the same value as the tributary port value designated previously. Accordingly, it can be identified which ODTU3y4e signal is mapped to which one of the 8 extra tributary slots.

Meanwhile, other signals other than ODU3+ also can use extra tributary slots in the same manner. Only in the case of ODU0 in which two signals are set in pair, as illustrated in FIG. 13, one signal can be mapped to Extra TS1a and the other one can be mapped to Extra TS1b. In the case of ODU1, 8 extra tributary slots may be set and used independently, and if the same value as that designated in the MSI bytes is set in the EMSI bytes, extra tributary slots may be used.

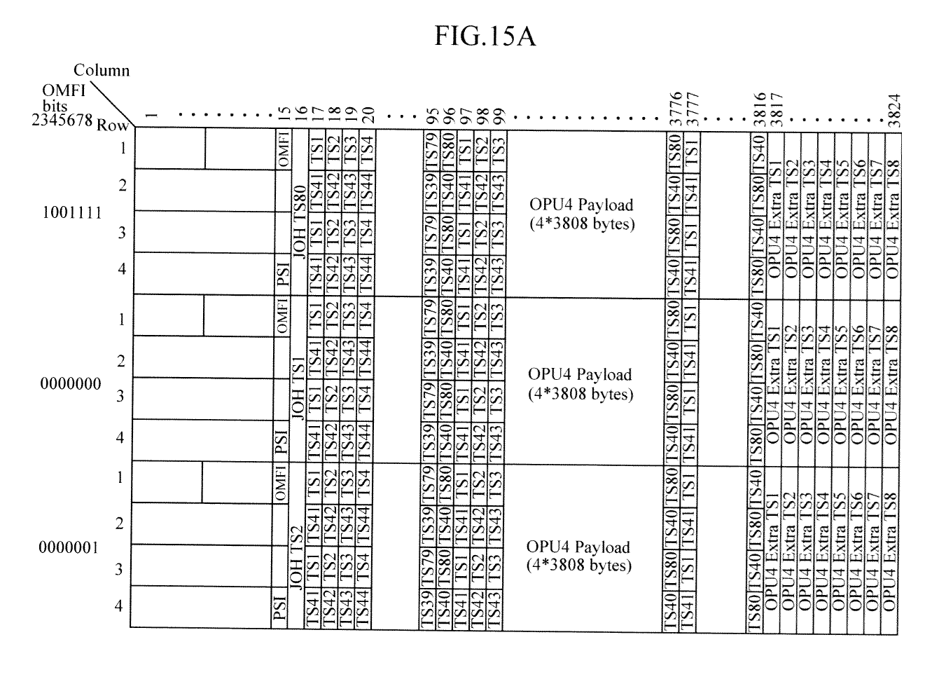

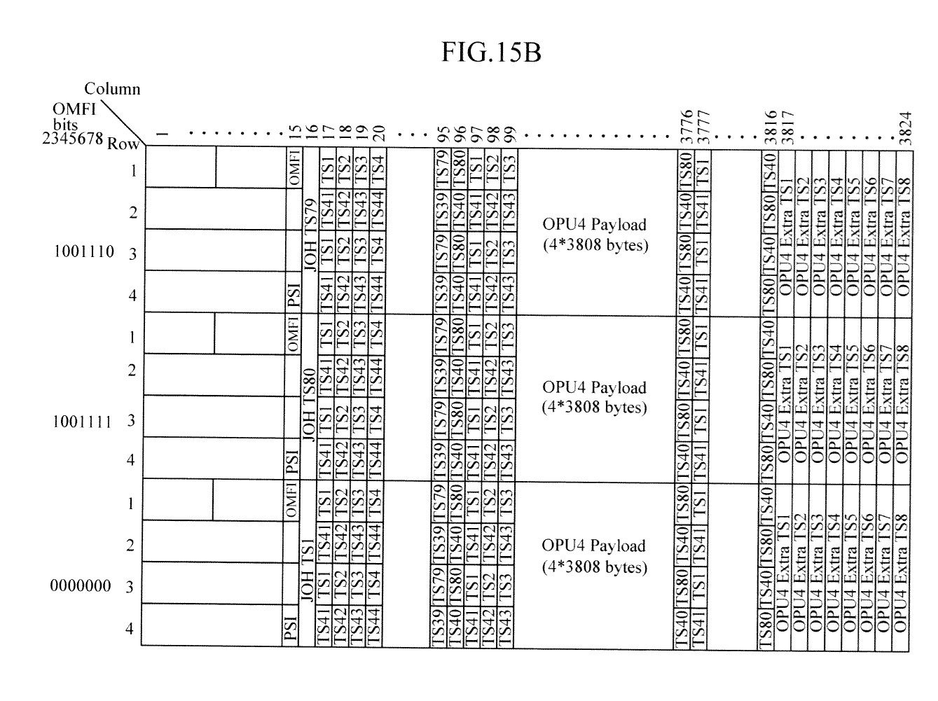

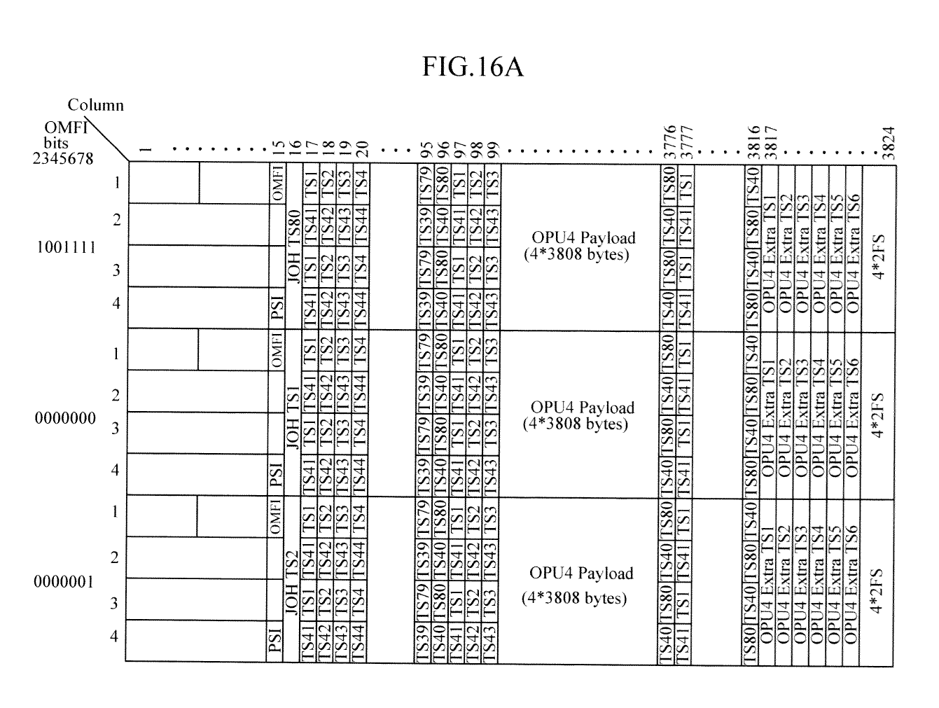

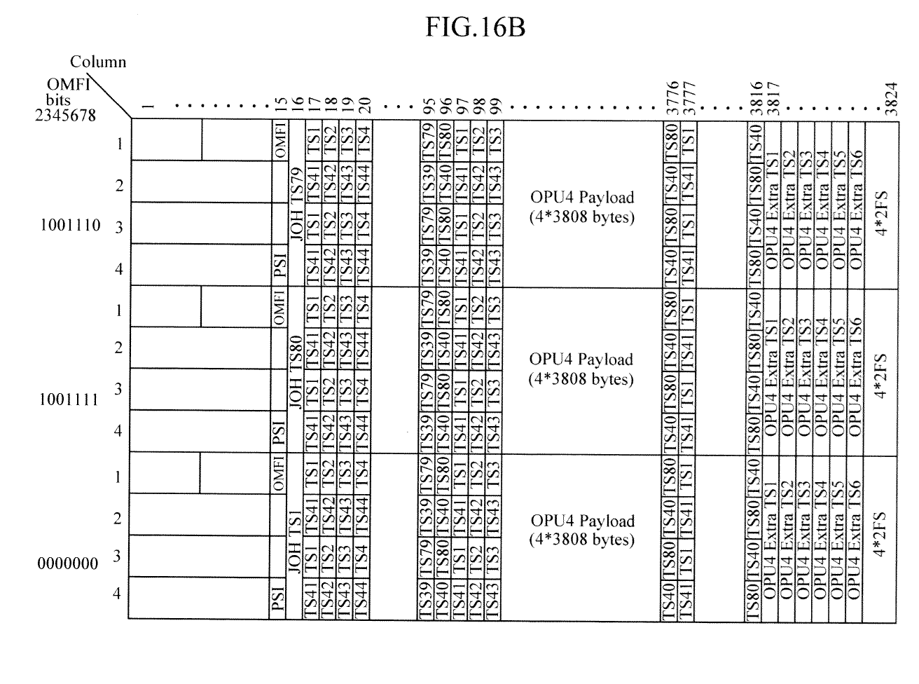

FIGS. 15A, 15B, 16A and 16B illustrate tributary slot allocated structures of OPU4e in which extra tributary slots are used, according to other exemplary embodiments.

Referring to FIGS. 15A and 15B, the client signal transporting apparatus allocates 3817^{th} to 3824^{th} byte columns of the entire 3808 byte columns of an OPU4e payload, to extra tributary slots. At this time, the client signal transporting apparatus divides the byte columns equally in units of 80 1.25 G tributary slots by allocating the byte columns, successively, row by row, unlike the tributary slot allocation structure illustrated in FIGS. 6A and 6B in which tributary slots are allocated column by column. For example, as illustrated in FIGS. 15A and 15B, a final payload byte located at the 3816^{th} column of a first row of the payload may be allocated to a 40^{th} tributary slot (TS40) and the first payload byte of the second row may be allocated to a 41^{st} tributary slot (TS41). Also, the final payload byte of the second row may be allocated to an 80^{th} tributary slot (TS80). Accordingly, 80 1.25 G tributary slots can be allocated equally for every two rows. In the tributary slot allocated structure of OTU4e as illustrated in FIGS. 15A and 15B, a bit rate of the OTU4e may be set to 111.9744 (9/8×40×2.48832) Gbit/s. In this case, is when ODU3+ is mapped into ODU4, ODU3+ may be mapped using only 32 tributary slots of 80 1.25 G tributary slots and 3 byte columns as extra tributary slots.

Meanwhile, 4 byte columns can be all used as extra tributary slots as illustrated in FIGS. 15A and 15B, however, as illustrated in FIGS. 16A and 16B, it is also possible that upon mapping two ODU3+ signals, 3 byte columns are used as extra tributary slots and the remaining 2 byte columns are used as FS bytes in order to support further extensibility. In this case, an ODU3+ signal may use the extra tributary slots 1, 3 and 5 and the other ODU3+ signal may use the extra tributary slots 2, 4 and 6. Also, the FS byte columns may be used as necessary.

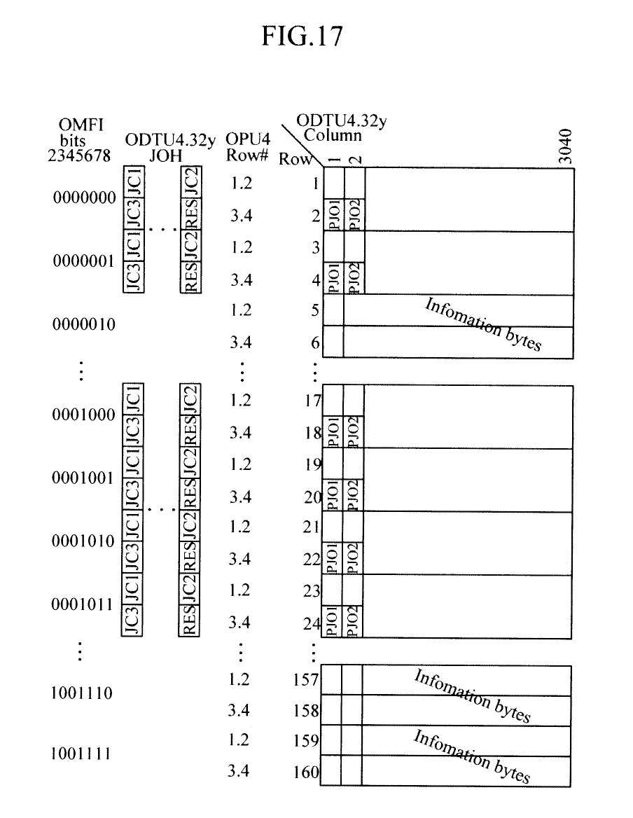

Meanwhile, a frame having the tributary slot allocated structure of OPU4e illustrated in FIGS. 15A and 15B and configured to be mapped to ODU4e using 32 tributary slots is called ODTU4e.32. Also, a frame having the tributary slot allocated structure of OPU4e illustrated in FIGS. 16A and 16B and configured to be mapped to ODU4e using 32 tributary slots and 3 byte columns is called ODTU4e.32y3. Here, the term “ODTU4e.32y3” means that it is a tributary unit of OTU4e, having 3 byte columns as extra tributary slots as well as 32 tributary slots. FIG. 17 illustrates an ODTU4e.32 frame structure that is used to multiplex 32 tributary slots of OTU4e, according to an exemplary embodiment.

Referring to FIG. 17, the client signal transporting apparatus may select as 32 tributary slots TS1, TS2, TS9, TS10, TS11, TS12, TS17, TS18, TS19, TS20, TS25, TS26, TS27, TS28, TS39, TS40, TS41, TS42, TS43, TS44, TS45, TS46, TS47, TS48, TS65, TS66, TS67, TS68, TS69, TS70, TS71 and TS72. Unlike ODTU3y4e using 40 tributary slots as a basic unit, to ODTU4e.32 uses 80 tributary slots as a basic unit. In ODTU4e.32, the first and second rows of OPU4e are integrated into one row to divide its payload area equally into units of 80 tributary slots.

When an AMP method is used to map ODU3+ into ODTU4e.32, PJ01 and PJ02 bytes may be allocated as illustrated in FIG. 17. Meanwhile, when a GMP method is used to map is ODU3+ into ODTU4e.32, JC1, JC2 and JC3 or more bytes are used and PJ01 and PJ02 bytes may be ignored as they are unnecessary.

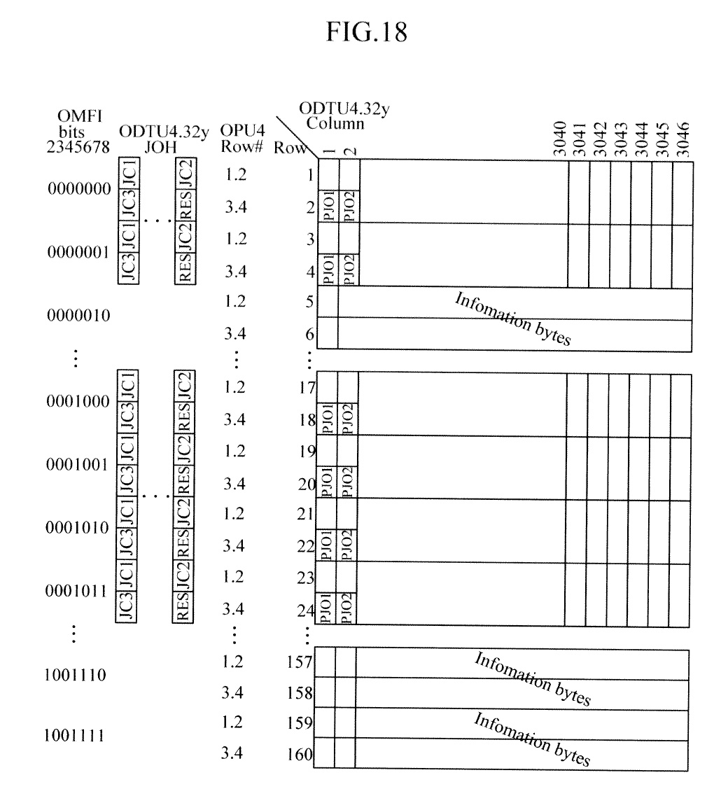

FIG. 18 illustrates an ODTU4e.32y3 frame structure to which 3 byte rows are added, according to an exemplary embodiment.

Referring to FIG. 18, since the client signal transporting apparatus uses 3 byte columns as extra tributary slots to map ODU3+ into ODU4e, 3 byte columns are added to a normal ODTU4e.32y3 frame structure. An ODTU4e.32y3 frame structure that uses 3 byte columns as extra tributary slots and 32 tributary slots is shown in FIG. 18. The 32 tributary slots allocated to the ODTU4e.32y3 frame structure may be selected as TS1, TS2, TS9, TS10, TS11, TS12, TS17, TS18, TS19, TS20, TS25, TS26, TS27, TS28, TS39, TS40, TS41, TS42, TS43, TS44, TS45, TS46, TS47, TS48, TS65, TS66, TS67, TS68, TS69, TS70, TS71 and TS72.

Meanwhile, since 3 byte columns are added for each row of OPU4e, as illustrated in FIG. 18, in an ODTU4e.32 frame structure, 6 bytes are added to the first row. The 6 bytes are allocated equally to all multiframes. Accordingly, the ODTU4e.32y3 frame structure shown in FIG. 18 is simpler than the frame structure shown in FIG. 4. Accordingly, the client signal transporting apparatus may map an ODU3+ signal into an ODTU4e.32y3 signal, and also may map an ODTU4e.32y3 signal easily into an ODU4e signal.

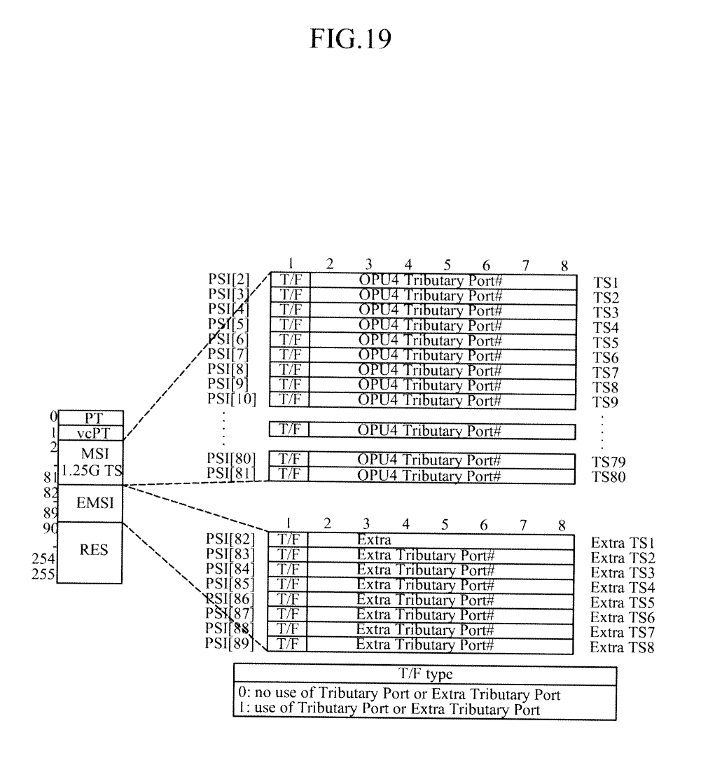

FIG. 19 illustrates a PSI structure of ODTU4e.32y3 used when an ODTU4e.32y3 signal is multiplexed to an ODU4e signal, according to an exemplary embodiment.

Referring to FIG. 19, the client signal transporting apparatus allocates 80 bytes to Multiplex Structure Identifier (MSI) bytes to support 80 tributary slots in a Payload Structure Identifier (PSI) consisting of 256 bytes of multiframes. Also, the client signal transporting apparatus allocates 8 bytes to EMSI bytes to use extra tributary slots.

Since the type of ODTU4e.32y3 is determined depending on the number of used tributary slots, separate bits for indicating an ODU type, which are illustrated in FIG. 12, are not needed. Accordingly, the client signal transporting apparatus supports 7 bits to the tributary port number of the MSI bytes so as to use maximally 80 tributary slots independently. The first bit of a MSI byte is used to identify whether the corresponding tributary slot is used. If the first bit of the MSI byte is zero, it is determined that the corresponding tributary slot is not used, which means that no information data is transported through the corresponding tributary slot. If the first bit of the MSI byte is 1, it means that the corresponding tributary slot is used.

In addition, if the client signal transporting apparatus has to use extra tributary slots, the client signal transporting apparatus may use EMSI bytes to identify a multiplex structure of extra tributary slots. At this time, the client signal transporting apparatus supports 7 bits such that bits corresponding to the same number as the number of tributary ports of MSI bytes are allocated to the extra tributary ports of EMSI bytes with respect to a tributary signal requiring extra tributary slots. Also, the remaining first bit of the EMSI bytes is used to identify whether extra tributary slots are used. That is, if the first bit of the EMSI byte is zero, then this means that no extra tributary slot is allocated, and if the first bit of the EMSI byte is 1, then this means that an extra tributary slot is used.

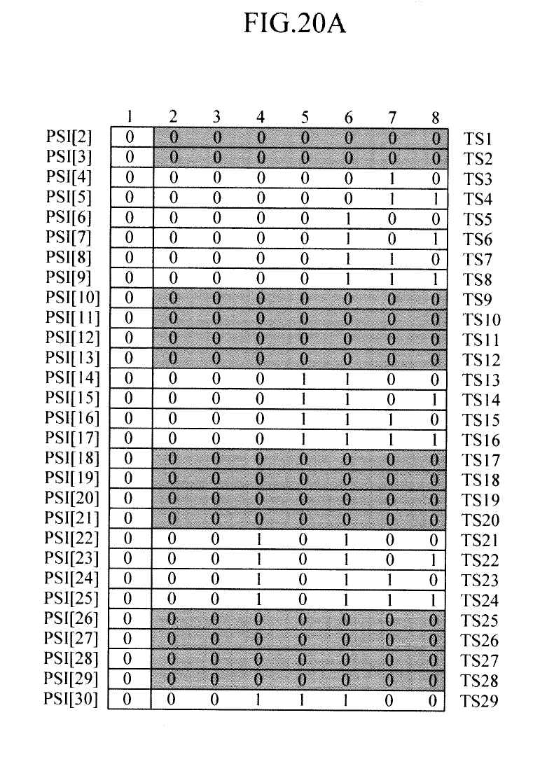

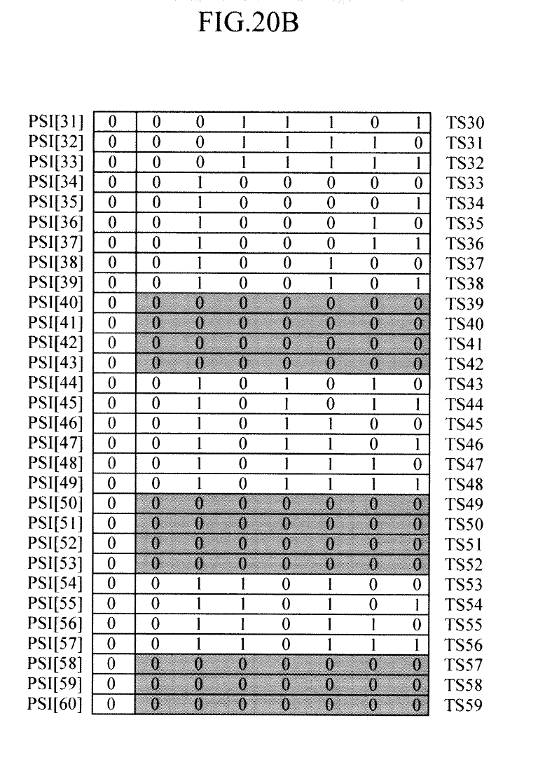

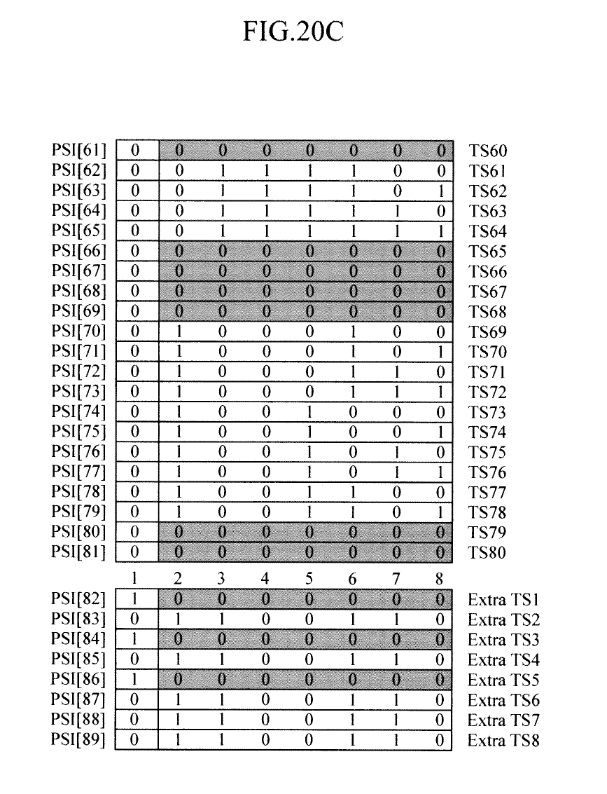

FIGS. 20A, 20B and 20C show an example of MFI and EMFI bytes illustrated in FIG. 19. Referring to FIGS. 20A, 20B and 20C, tributary slots used for ODTU4e.32y3 may be TS1, TS2, TS9, TS10, TS11, TS12, TS17, TS18, TS19, TS20, TS25, TS26, TS27, TS28, TS39, TS40, TS41, TS42, TS49, TS50, TS51, TS52, TS57, TS58, TS59, TS60, TS65, TS66, TS67, TS68, TS79 and TS80, and extra tributary slots may be Extra TS1, Extra TS3 and Extra TS5.

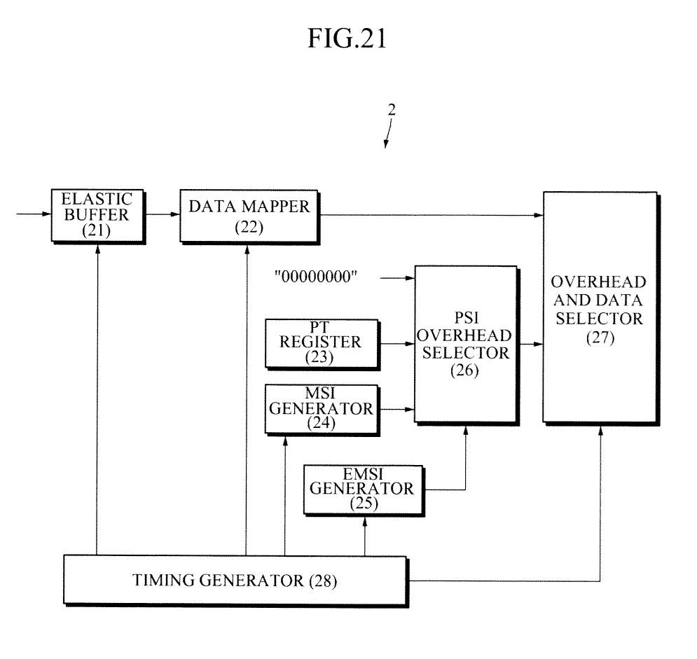

FIG. 21 illustrates a configuration of an extra tributary slot mapping apparatus 2 according to an exemplary embodiment. Referring to FIG. 21, the extra tributary slot mapping apparatus 2 includes an elastic buffer 21, a data mapper 22, a PT register 23, a MSI generator 24, an EMSI generator 25, a PSI overhead selector 26, an overhead and data selector 27 and a timing generator 28.

The elastic buffer 21 receives a data output timing signal from the timing generator 28 and transfers it to the data mapper 22 while storing a tributary signal to be mapped. The data mapper 22 receives timing information about a frame to be created and timing information of tributary slots and extra tributary slots to be mapped, from the timing generator 28, and maps data received through the elastic buffer 21 to a corresponding tributary slot.

The PT register 23 stores type information of tributary signals to be mapped, and the type information may be modified by a user. The MSI generator 24 receives a MSI timing signal of PSI multiframes from the timing generator 28 and generates tributary port information for 80 tributary ports that can be modified by a user. The EMSI generator 25 receives EMSI timing information among PSI multiframes from the timing generator 28 and generates tributary port information about 8 extra tributary slots, herein the tributary port information can be modified by a user.

The PSI overhead selector 26 receives PSI multiframe information from the timing generator 28, and selects a “0000000” value for the PT register 23, the MSI generator 24, the EMSI generator 24 and a reserve, so as to configure an overhead having a predetermined multiframe structure. The overhead and data selector 27 receives PSI overhead timing information and data timing information from the timing generator 28, and selects data and an overhead to transfer data mapped to tributary slots to a data area and transfer PIS information selected by the PSI overhead selector 26 to a PSI overhead area. An OPU4 overhead, an OTU4 overhead and an ODU4 overhead except for the PSI overhead may be added as necessary.

The timing generator 28 generates frame timing information, generates a signal regarding a timing at which the elastic buffer 21 will extract data, and then generates timing signals for tributary slots and extra tributary slots areas to be mapped and transfers the timing signals to the data mapper 22. Also, the timing generator 28 transfers timing information of each multiframe to create a PSI overhead to the MSI generator 24, the EMSI generator 25 and the PSI overhead selector 26, and provides PSI overhead timing information and data timing information to the overhead and data selector 27.

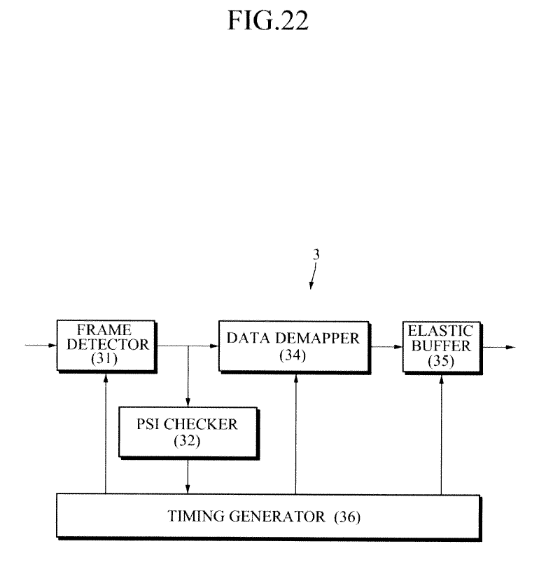

FIG. 22 illustrates a configuration of a tributary slot demapping apparatus 3 according to an exemplary embodiment. Referring to FIGS. 2A and 2B, the tributary slot demapping apparatus 3 includes a frame detector 31, a PSI checker 32, a data demapper 34, an elastic buffer 35 and a timing generator 38.

The frame detector 31 detects a start point of a received frame and informs the timing generator 36 of a frame start location. The timing generator 36 receives frame start information from the frame detector 31, generates information regarding a timing at which PSI information is to be extracted, and transfers the timing information to the PSI checker 32.

The PSI checker 32 extracts PSI information from among data received from the frame detector 31 according to the PSI timing information received from the timing generator 36. The extracted PSI information includes a payload type and MSI and EMSI information according to multiframes. Multiplex structured information of tributary slots obtained from the MSI information and multiplex structured information of extra tributary slots obtained from EMSI information are transferred to the timing generator 36.

The timing generator 36 generates timing information of tributary slots and extra tributary slots areas to be demapped according to the multiplex structured information of the tributary slots and extra tributary slots received from the frame detector 31, and transfers the timing information to the data demapper 34.

The data demapper 34 receives timing information of tributary slots and extra tributary slots of areas to be demapped, from the timing generator 36, with respect to a frame coming through the frame detector 31, and demaps a data signal. The demapped data signal is stored in the elastic buffer 35.

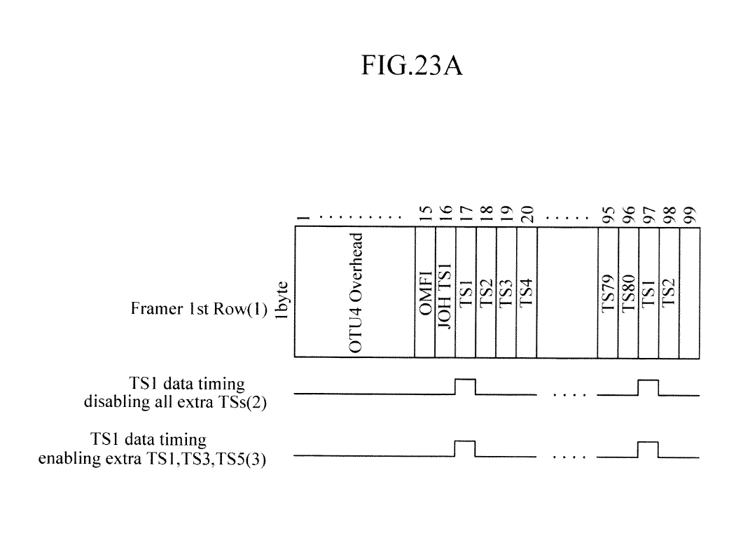

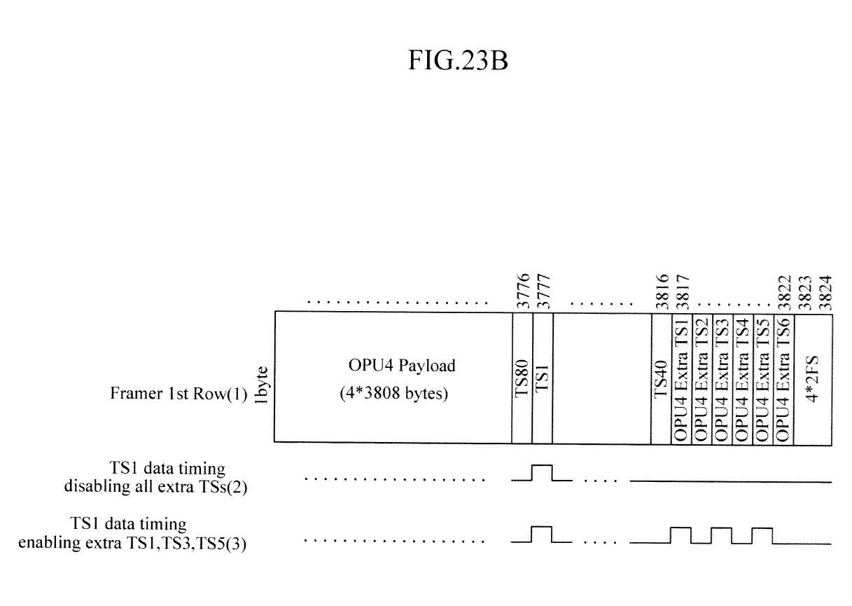

FIGS. 23A and 23B show timing diagrams regarding tributary slots and extra tributary slots areas that are demapped by the tributary slot demapping apprauts, according to an exemplary embodiment.

Referring to FIGS. 23A and 23B, a timing diagram (1) is a timing diagram where the first row of an OTU4 frame is shown in a unit of 1 byte, a timing diagram (2) is a demapping timing diagram when a tributary signal is mapped only to a tributary slot 1 without using any extra tributary slot, and a timing diagram (3) is a timing diagram for tributary slots and extra tributary slot areas to demap a tributary signal which uses extra tributary slots 1, 3 and 5 as extra mapping areas. The extra tributary slot demapping apparatus 3 determines whether extra tributary slots are used and transfers, if extra tributary slots are used, information on which extra tributary slots are sent to the timing generator 36. Accordingly, the timing generator 36 generates a signal which is represented as the timing diagram (2) when no extra tributary slot is used, and generates a signal which is represented as the timing diagram (3) when the tributary slot 1 and extra tributary slots 1, 3 and 5 are used.

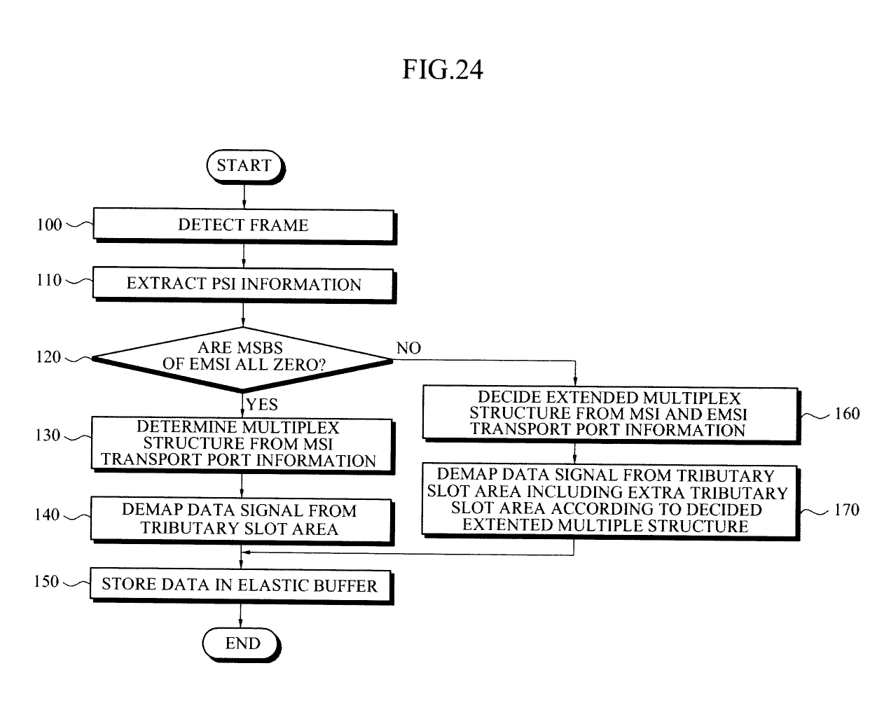

FIG. 24 is a flowchart illustrating a tributary slot demapping method according to an exemplary embodiment.

Referring to FIG. 24, the tributary slot demapping apparatus 3 first detects a frame to acquire a timing of the frame (operation 100). Then, the tributary slot demapping apparatus 3 calculates a location of payload structure identifier (PSI) information according to the detected frame and extracts PSI information from the frame (operation 110).

Successively, the tributary slot demapping apparatus 3 determines whether all the MSBs of 8 bytes of extended EMSI information in extracted PSI information are zero (operation 120). If all the MSB bits are zero, multiplex structure information is determined from MSI tributary port information (operation 130). Since the determined multiplex structure corresponds to a mapping method in which no extra tributary slot is used, a data signal from a tributary slot area is demapped (operation 140). Successively, the demapped data is stored in the elastic buffer (operation 150). If not all the MSBs of 8 bytes of extended EMSI information in the extracted PSI information are zero, an extended multiplex structure is decided from the MSI and EMSI tributary port information (operation 160). A data signal is demapped from a tributary slot area including an extra tributary slot area according to the decided extended multiplex structure (operation 170). Then, the demapped data is stored in the elastic buffer (operation 150).

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A client signal transporting apparatus which transports a client signal using the Optical Transport Hierarchy (OTH) over an optical transport network, comprising:
a tributary slot allocation unit to allocate a part of a payload area of an optical transport signal equally in units of a predetermined number of tributary slots and to allocate the remaining part of the payload area in units of a predetermined number of extra tributary slots or a predetermined number of fixed stuff bytes; and
an optical multiplexing unit to map a client signal into the payload area using the to allocated tributary slots and the allocated extra tributary slots and multiplex the mapped client signal into a higher layer optical transport signal.

2. The client signal transporting apparatus of claim 1, wherein the optical multiplexing unit defines a bit rate of an optical channel data unit 3+ (ODU3+) corresponding to the optical transport signal and a bit rate of an optical channel data unit 4e (ODU4e) corresponding to the higher layer optical transport signal, and multiplexes the ODU3+ into the ODU4e using the allocated tributary slots and the allocated extra tributary slots at the defined bit rates.

3. The client signal transporting apparatus of claim 2, wherein the optical multiplexing unit maps 4 10 GbE signals or one 40 GbE signal to ODU3+ at the bit rate of the ODU4e and multiplexes the ODU3+ into the ODU4e, and the bit rate of the ODU4e is 112.3047 Gbit/s (255/226×40×2.48832 Gbit/s) or the bit rate of the ODU4e is in a range from 111.83688 Gbit/s (102/95×80/32×239/255×243/217×16×2.48832 Gbit/s) to 112.16234 Gbit/s (4080/1524×239/236×4×10.3125 Gbit/s).

4. The client signal transporting apparatus of claim 3, wherein the bit rate of the ODU3+ is in a range from 41.774 Gbit/s (239/236×4×10.3125 Gbit/s) to 41.84 Gbit/s (3800/3808×32/80×238/226×40×2.48832 Gbit/s).

5. The client signal transporting apparatus of claim 2, wherein when an ODU4 or ODU4e signal is used as the optical transport signal, the predetermined number of tributary slots to be allocated to the part of the payload area of the optical transport signal is 40 or 80.

6. The client signal transporting apparatus of claim 1, wherein the tributary slot allocation unit allocates the part of the payload area of the optical transport signal in units of the predetermined number of tributary slots, and allocates the remaining part of the payload area in units of the predetermined number of tributary slots, in units of the predetermined number of tributary slots and the predetermined number of extra tributary slots, or in units of the predetermined number of tributary slots, the predetermined number of extra tributary slots and the predetermined number of fixed stuff bytes, using a predetermined number of multiframes.

7. The client signal transporting apparatus of claim 6, wherein the optical multiplexing unit multiplexes the optical transport signal into the higher layer optical transport signal using multiplex structure identifiers (MSIs) for identifying the extra tributary slots.

8. The client signal transporting apparatus of claim 1, wherein the tributary slot allocation unit allocates the part of the payload area of optical transport signal in units of the predetermined number of tributary slots row by row, and allocates the remaining part of the payload area either in units of the predetermined number of extra tributary slots or in units of the predetermined number of extra tributary slots and the predetermined number of fixed stuff bytes.

9. The client signal transporting apparatus of claim 1, wherein the client signal is a packet signal such as an Ethernet hierarchy signals, a synchronous signal or a successive signal such as a video signal.

10. The client signal transporting apparatus of claim 1, wherein for the multiplexing into the higher layer optical transport signal, the optical multiplexing unit allocates ODU type information and tributary port information for the tributary slots to a multiplex structure identifier of an ODU overhead area, and allocates the ODU type information and extra tributary port information for the extra tributary slots to an extended structure identifier of the ODU overhead area.

11. The client signal transporting apparatus of claim 1, wherein for the multiplexing into the higher layer optical transport signal, the optical multiplexing unit allocates identification information for identifying whether or not the tributary slots are used, and tributary port information for the tributary slots, to a multiplex structure identifier of an ODU overhead area, and allocates identification information for identifying whether or not the extra tributary slots are used, and extended tributary port information for the extra tributary slots, to an extended multiplex structure identifier.

12. A tributary slot mapping apparatus which transports a client signal using the optical transport hierarchy (OTH) over an optical transport network, comprising:
a data mapper to map data into tributary slots;
a multiplex structure identifier generator to generate tributary port information for the tributary slots;
an extended multiplex structure identifier generator to generate extra tributary port information for extra tributary slots; and
an overhead and data selecting unit to set an overhead to transfer a payload structure identifier including the multiplex structure identifier and the extended multiplex structure identifier to an overhead area of the payload structure identifier, and to transfer the data mapped to the tributary slots to a data area.

13. A tributary slot demapping apparatus which transports a client signal using the optical transport hierarchy (OTH) over an optical transport network, comprising:
a frame extracting unit to receive a mapped frame and extract payload structure identifier information from the mapped frame;
a payload structure identifier checker to verify whether the most significant bits of extended multiplex structure identifier information are all zero in the payload structure identifier information; and
is a data demapper to decode, if the most significant bits of the extended multiplex structure identifier information are all zero, multiplex structure information using tributary port information of the payload structure identifier and demap a data signal from a tributary slot area according to the decided multiplex structure information, and to decode, if all of the most significant bits of the extended multiplex structure identifier information are not zero, extended multiplex structure information using tributary port information of the multiplex structure identifier and the extended multiplex structure identifier and demap a data signal from a tributary slot area including an extra tributary slot area according to the decided, extended multiplex structure information.

14. A client signal transporting method which transports a client signal using the optical transport hierarchy (OTH) over an optical transport network, comprising:
allocating a part of a payload area of an optical transport signal equally in units of a predetermined number of tributary slots, and allocating the remaining part of the payload area in units of a predetermined tributary slots or in units of a predetermined number of fixed stuff bytes; and
mapping a client signal into the payload area using the allocated tributary slots and the allocated extra tributary slots, and multiplexing the mapped client signal into a higher layer optical transport signal.

15. The client signal transporting method of claim 14, wherein the multiplexing of the client signal into the higher layer optical transport signal comprises defining a bit rate of an optical channel data unit 3+ (ODU3+) corresponding to the optical transport signal and a bit rate of an optical channel data unit 4e (ODU4e) corresponding to the higher layer optical transport signal, and multiplexing the ODU3+ into the ODU4e using the allocated tributary slots and the allocated extra tributary slots at the defined bit rates.

16. The client signal transporting method of claim 15, wherein the multiplexing of the client signal into the higher layer optical transport signal comprises mapping 4 10 GbE signals or one 40 GbE signal to ODU3+ at the bit rate of the ODU4e and multiplexing the ODU3+ into the ODU4e, and the bit rate of the ODU4e is 112.3047 Gbit/s (255/226×40×2.48832 Gbit/s) or is in a range of from 111.83688 Gbit/s (102/95×80/32×239/255×243/217×16×2.48832 Gbit/s) to 112.16234 Gbit/s (4080/1524×239/236×4×10.3125 Gbit/s).

17. The client signal transporting method of claim 16, wherein the bit rate of the ODU3+ is in a range of from 41.774 Gbit/s (239/236×4×10.3125 Gbit/s) to 41.84 Gbit/s (3800/3808×32/80×238/226×40×2.48832 Gbit/s).

18. The client signal transporting method of claim 14, wherein when an ODU4 or ODU4e signal is used as the optical transport signal, the predetermined number of tributary slots to be allocated to the part of the payload area of the optical transport signal is 40 or 80.

19. The client signal transporting method of claim 14, wherein the multiplexing of the client signal into the higher layer optical transport signal comprises multiplexing the optical transport signal into the higher layer optical transport signal using a multiplex structured identifier for identifying the extra tributary slots.
